(19) United States
(12) Patent Application Publication
(10) Pub. No.: US 2026/0362415 A1
(43) Pub. Date: Nov. 12, 2026

(54) UPLINK RESOURCE MUTING CONFIGURATIONS

(71) Applicant: QUALCOMM Incorporated, San Diego, CA (US)

(72) Inventors: Qian ZHANG, Basking Ridge, NJ (US); Muhammad Sayed Khairy ABDELGHAFFAR, San Jose, CA (US)

(21) Appl. No.: 19/203,100

(22) Filed: May 8, 2025

(51) Int. Cl. H04W 72/1268; H04L 5/14; H04W 72/231

(52) U.S. Cl. CPC H04W 72/1268; H04L 5/14; H04W 72/231

(57) ABSTRACT

Various aspects of the present disclosure generally relate to wireless communication. In some aspects, a user equipment (UE) may obtain an uplink (UL) resource muting configuration indication related to a plurality of symbols, the UL resource muting configuration indication indicating whether to apply UL resource muting to at least one non-SBFD symbol of a set of non-SBFD symbols among the plurality of symbols. The UE may transmit, to a network node, a physical uplink shared channel (PUSCH) message in one or more symbols, of the plurality of symbols, in accordance with the UL resource muting configuration indication. Numerous other aspects are described.

### FIELD OF THE DISCLOSURE

Aspects of the present disclosure generally relate to wireless communication and specifically relate to techniques, apparatuses, and methods associated with uplink resource muting configurations.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

“Full-duplex communication” in a wireless network refers to simultaneous bi-directional communication between devices in the wireless network. In sub-band full duplex (SBFD), a network node may receive an uplink communication from a user equipment (UE) and transmit a downlink communication to a UE at the same time, but on different frequency resources. In some scenarios, SBFD operation may lead to inter-network-node cross-link interference (CLI). Inter-network-node CLI may occur when reception of a communication (e.g., from a UE) at a network node overlaps in time with transmission of a communication from a neighboring network node.

### SUMMARY

The systems, methods, and devices of this disclosure each have several innovative aspects, no single one of which is solely responsible for the desirable attributes disclosed herein.

Some aspects described herein relate to a user equipment (UE). The UE may include a processing system. The processing system may include one or more processors and one or more code-storing memories coupled with the one or more processors. The processing system may be configured to obtain an uplink (UL) resource muting configuration indication related to a plurality of symbols, the UL resource muting configuration indication indicating whether to apply UL resource muting to at least one non-SBFD symbol of a set of non-SBFD symbols among the plurality of symbols. The processing system may be configured to transmit, to a network node, a physical uplink shared channel (PUSCH) message in one or more symbols, of the plurality of symbols, in accordance with the UL resource muting configuration indication.

Some aspects described herein relate to a network node. The network node may include a processing system. The processing system may include one or more processors and one or more code-storing memories coupled with the one or more processors. The processing system may be configured to transmit, to a UE, a UL resource muting configuration indication related to a plurality of symbols, the UL resource muting configuration indication indicating whether to apply UL resource muting to at least one non-SBFD symbol of a set of non-SBFD symbols among the plurality of symbols. The processing system may be configured to receive, from the UE, a PUSCH message in one or more symbols, of the plurality of symbols, in accordance with the UL resource muting configuration indication.

Some aspects described herein relate to a method of wireless communication performed by a UE. The method may include obtaining a UL resource muting configuration indication related to a plurality of symbols, the UL resource muting configuration indication indicating whether to apply UL resource muting to at least one non-SBFD symbol of a set of non-SBFD symbols among the plurality of symbols. The method may include transmitting, to a network node, a PUSCH message in one or more symbols, of the plurality of symbols, in accordance with the UL resource muting configuration indication.

Some aspects described herein relate to a method of wireless communication performed by a network node. The method may include transmitting, to a UE, a UL resource muting configuration indication related to a plurality of symbols, the UL resource muting configuration indication indicating whether to apply UL resource muting to at least one non-SBFD symbol of a set of non-SBFD symbols among the plurality of symbols. The method may include receiving, from the UE, a PUSCH message in one or more symbols, of the plurality of symbols, in accordance with the UL resource muting configuration indication.

Some aspects described herein relate to a non-transitory computer-readable medium that stores a set of instructions for wireless communication by a UE. The set of instructions, when executed by one or more processors of the UE, may cause the UE to obtain a UL resource muting configuration indication related to a plurality of symbols, the UL resource muting configuration indication indicating whether to apply UL resource muting to at least one non-SBFD symbol of a set of non-SBFD symbols among the plurality of symbols. The set of instructions, when executed by one or more processors of the UE, may cause the UE to transmit, to a network node, a PUSCH message in one or more symbols, of the plurality of symbols, in accordance with the UL resource muting configuration indication.

Some aspects described herein relate to a non-transitory computer-readable medium that stores a set of instructions for wireless communication by a network node. The set of instructions, when executed by one or more processors of the network node, may cause the network node to transmit, to a UE, a UL resource muting configuration indication related to a plurality of symbols, the UL resource muting configuration indication indicating whether to apply UL resource muting to at least one non-SBFD symbol of a set of non-SBFD symbols among the plurality of symbols. The set of instructions, when executed by one or more processors of the network node, may cause the network node to receive, from the UE, a PUSCH message in one or more symbols, of the plurality of symbols, in accordance with the UL resource muting configuration indication.

Some aspects described herein relate to an apparatus for wireless communication. The apparatus may include means for obtaining a UL resource muting configuration indication related to a plurality of symbols, the UL resource muting configuration indication indicating whether to apply UL resource muting to at least one non-SBFD symbol of a set of non-SBFD symbols among the plurality of symbols. The apparatus may include means for transmitting, to a network node, a PUSCH message in one or more symbols, of the plurality of symbols, in accordance with the UL resource muting configuration indication.

Some aspects described herein relate to an apparatus for wireless communication. The apparatus may include means for transmitting, to a UE, a UL resource muting configuration indication related to a plurality of symbols, the UL resource muting configuration indication indicating whether to apply UL resource muting to at least one non-SBFD symbol of a set of non-SBFD symbols among the plurality of symbols. The apparatus may include means for receiving, from the UE, a PUSCH message in one or more symbols, of the plurality of symbols, in accordance with the UL resource muting configuration indication.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless communication network.

FIG. 2 is a diagram showing an example downlink-centric slot or communication structure and an uplink-centric slot or communication structure.

FIG. 3 is a diagram illustrating an example of physical uplink shared channel (PUSCH) Repetition Type A and PUSCH Repetition Type B.

FIG. 4 is a diagram illustrating examples of full-duplex communication in a wireless network.

FIGS. 5A-5D are diagrams illustrating an example of sub-band full duplex (SBFD) activation, an example of configurations for SBFD transmissions and receptions across SBFD and non-SBFD symbols, and examples of cross-link interference scenarios.

FIG. 6 is a diagram of an example implementation associated with UL resource muting configurations.

FIG. 7 is a diagram illustrating an example process performed, for example, at a user equipment (UE) or an apparatus of a UE.

FIG. 8 is a diagram illustrating an example process performed, for example, at a network node or an apparatus of a network node.

FIGS. 9-10 are diagrams of example apparatuses for wireless communication.

### DETAILED DESCRIPTION

“Full-duplex communication” in a wireless network refers to simultaneous bi-directional communication between devices in the wireless network. In sub-band full duplex (SBFD), a network node may receive an uplink (UL) communication from a user equipment (UE) and transmit a downlink (DL) communication to a UE at the same time, but on different frequency resources. In some examples, SBFD operation may lead to inter-network-node cross-link interference (CLI). Inter-network-node CLI may occur when reception of a communication (e.g., from a UE) at a network node overlaps in time with transmission of a communication from a neighboring network node. For example, the communication transmitted from the neighboring network node may interfere with the communication received from the UE.

In some examples, UL resource muting may be used to support an inter-network-node CLI measurement and thereby suppress inter-network-node CLI. UL resource muting may involve muting of one or more UL resources (e.g., one or more UEs may refrain from transmitting UL communications on the UL resource(s)). “Muting” a resource refers to a wireless communication device refraining from using the resource (e.g., a time-frequency resource, such as a resource block (RB) or a resource element (RE)) for communication of data or control information (e.g., for transmission or reception of data or control information). As an example, a first network node (e.g., a victim network node) may receive a CLI reference signal from a second network node (e.g., an aggressor network node). The first network node may measure the CLI reference signal in order to determine a CLI level caused by the second network node. In order to accurately measure the CLI reference signal to obtain the CLI level, the first network node may mute a UL transmission from a UE associated with the first network node, such that an entire UL channel at a given time is dedicated for measuring the CLI reference signal. The UL transmission may be muted when a timing of the UL transmission corresponds to a timing of the CLI reference signal. The UE and the first network node may be associated with a same cell.

When the UL transmission is not muted, an accuracy of a CLI reference signal measurement may be degraded, which may result in a less accurate measurement of the CLI level. A muting of the UL transmission may be referred to as a UL resource muting, such that certain UL resources are not used for the UL transmission in order to improve a measurement accuracy of the CLI reference signal. The UL resource muting may be a non-transparent UL resource muting, in which case the UE obtains an indication of the UL resource muting.

In addition to SBFD scenarios, dynamic time division duplexing (TDD) systems may further complicate CLI measurement or mitigation. Dynamic TDD systems allow flexible UL/DL resource allocation, which can result in varying slot formats across cells. Misaligned slot configurations between neighboring cells (e.g., one cell operating in a DL slot while another operates in a UL slot) can increase inter-cell CLI. This dynamic nature makes it challenging to apply consistent CLI mitigation techniques across all deployment scenarios.

Further, there may be inconsistent signaling regarding when and where UL resource muting should be applied. For example, some UEs may receive configuration information (e.g., via system information block (SIB) or radio resource control (RRC) signaling) indicating SBFD time and frequency locations. However, UEs that do not receive such configuration information may default to applying muting inconsistently, which can lead to either performance degradation or insufficient CLI mitigation. Additionally, signaling mechanisms to indicate muting for non-SBFD symbols are either absent or undefined, leaving UEs unable to adapt muting behavior based on network conditions.

For example, such inconsistencies may be present in heterogeneous deployment scenarios where SBFD-aware UEs coexist with UEs operating in dynamic TDD systems (e.g., non-SBFD modes). As a result, communication reliability, spectral efficiency, and system performance in TDD-based wireless networks may be relatively lower. For example, UL resource muting inconsistencies between SBFD and non-SBFD symbols may cause excessive muting and hinder effective CLI mitigation.

Various aspects relate generally to enabling effective mitigation of CLI in TDD communication systems. Some aspects more specifically relate to enabling a UE to obtain a UL resource muting configuration indication related to a plurality of symbols, including SBFD symbols and non-SBFD symbols, and transmitting a physical uplink shared channel (PUSCH) message in one or more symbols, in accordance with the UL resource muting configuration indication. For example, the UL resource muting configuration indication may specify whether UL resource muting should be applied to SBFD symbols, non-SBFD symbols, or both.

In some aspects, the UL resource muting configuration indication may be provided via a network node using signaling mechanisms, such as RRC signaling or a SIB (e.g., a first SIB (SIB1)) message. The UL resource muting configuration indication may include fields to indicate time and frequency locations of symbols to which UL resource muting should be applied. The indication may also specify the muting pattern, such as muting alternating resource elements within symbols to assist in CLI mitigation without compromising overall data transmission efficiency.

In some aspects, the UL resource muting configuration indication may include a single bit or a bitmap to indicate muting configurations at symbol or slot levels. For example, a bitmap may indicate whether muting is utilized for specific non-SBFD symbols in misaligned slots. Additionally, the UL resource muting configuration indication may include configurations for muting behavior in cases where the indication is absent or not explicitly configured. For example, the UE may apply UL muting only to SBFD symbols if no explicit configuration is received, or may apply UL muting to non-SBFD symbols if the network node does not support an SBFD mode.

Particular aspects of the subject matter described in this disclosure can be implemented to realize one or more of the following potential advantages. By enabling precise UL resource muting configuration indications, the described techniques can mitigate CLI in SBFD, non-SBFD, or dynamic TDD scenarios, including in misaligned slot configurations across neighboring cells. This may result in a reduction in interference between UL and DL transmissions, thereby improving spectral efficiency and conserving network resources, such as transmission power and bandwidth.

In some aspects, by applying UL resource muting only to certain symbols or slots (e.g., misaligned non-SBFD symbols), the described techniques may reduce excessive resource utilization caused by over-muting. This selective muting may conserve processing resources and transmission resources while maintaining effective CLI mitigation tailored to deployment conditions, such as dynamic TDD and SBFD deployments.

In further aspects, enabling consistent signaling mechanisms (e.g., RRC signaling and SIB messages) to convey muting configurations may improve coordination between UEs and network nodes, thereby reducing ambiguity in CLI mitigation strategies and conserving signaling bandwidth. Additionally, implementing a previously received configuration when configuration indications are absent ensures predictable and reliable behavior across UEs, reducing the probability of excessive network overhead and ensuring robust system performance. In this way, the described techniques may conserve processing resources, network signaling resources, or transmission resources while maintaining effective CLI mitigation strategies.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, SBFD), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

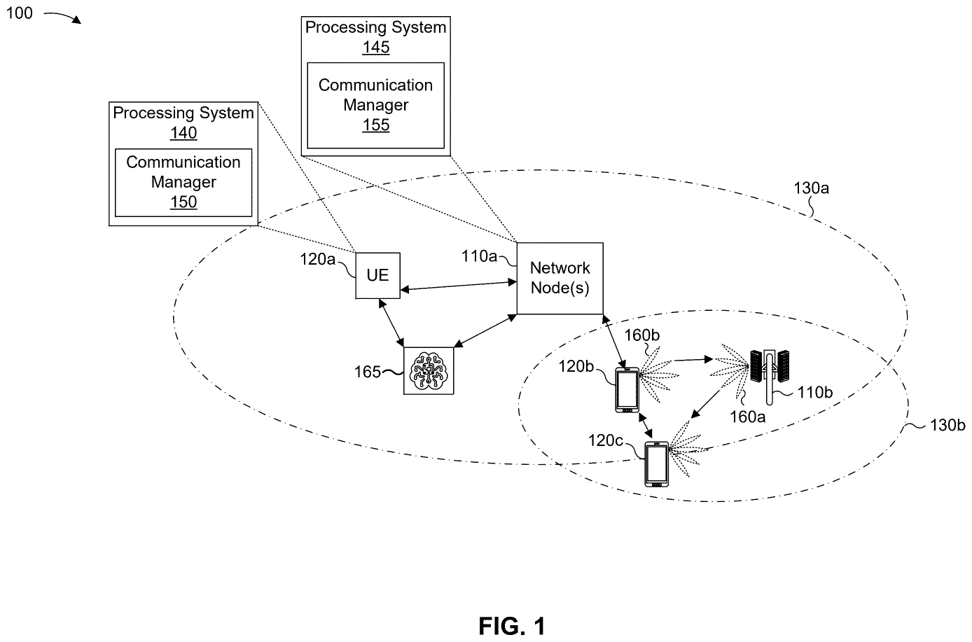

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as an RRC layer, a packet data convergence protocol (PDCP) layer, and a service data adaptation protocol (SDAP) layer, among other examples. A CU can communicate with a core network either directly (for example, via a backhaul link) or indirectly (for example, via one or more disaggregated control units, such as a non-real-time (Non-RT) RAN intelligent controller (RIC) associated with a Service Management and Orchestration (SMO) framework or a near-real-time (Near-RT) RIC). A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. A CU may communicate with one or more DUs via respective midhaul links, such as via F1 interfaces. Each of the DUs may communicate with one or more RUs via respective fronthaul links. Each of the RUs may communicate with one or more UEs 120 via respective RF access links. In some deployments, a UE 120 may be simultaneously served by multiple RUs.

In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment (for example, an open cloud (O-Cloud) platform). An SMO framework may support RAN deployment and provisioning of non-virtualized and virtualized network elements.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a DL and a UL. “Downlink” (or “DL”) refers to a communication direction from a network node 110 to a UE 120, and “uplink” (or “UL”) refers to a communication direction from a UE 120 to a network node 110. DL and UL resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of RBs within a full component carrier bandwidth) that may be configured at a UE-specific level. In other words, within the carrier bandwidth, a BWP starts at a specifically configured RB and may span a specific set of consecutive RBs. A UE 120 may be configured with both a UL BWP and a DL BWP (which may be the same or different). Each BWP may be associated with its own numerology (indicating a sub-carrier spacing (SCS) and cyclic prefix (CP)). A UE 120 may be configured with up to four DL BWPs and up to four UL BWPs for each serving cell. To reduce UE power consumption, only one BWP in the DL and one BWP in the UL are generally active at a given time on an active serving cell under typical operation. A BWP may be dynamically configured or activated (for example, by a network node 110 transmitting a DL control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell. On deactivated BWPs, the UE 120 does not transmit or receive any communications.

A BWP may be an initial BWP (for example, an initial UL BWP or an initial DL BWP), a first active BWP, or a default BWP, among other examples. An initial BWP may be used by a UE 120 for initial access (for example, for a random access procedure), synchronization, or channel estimation, among other examples. A first active BWP may be a BWP that is to be active for the UE 120 after initial access is completed. A default BWP may be a BWP to which the UE switches based on, or otherwise associated with, detecting no activity on an active BWP for a given amount of time (for example, where the given amount of time is based on a configured BWP inactivity timer). In some examples, the UE 120 may switch between an active BWP and another BWP (for example, an inactive BWP or the default BWP). This may be referred to as BWP switching. In some examples, the UE 120 may switch BWPs based on, or otherwise associated with, receiving an indication to switch the active BWP (for example, where the indication is included in DCI or an RRC message from a network node 110). As another example, the UE 120 may switch BWPs based on, or otherwise associated with, detecting no activity on an active BWP for a given amount of time (for example, where the given amount of time is based on a configured BWP inactivity timer). As another example, the UE 120 may switch BWPs based on, or otherwise associated with, performing a given operation or procedure. For example, the UE 120 may switch to an initial BWP based on, or otherwise associated with, performing a random access procedure.

A network node 110 or a UE 120 operating in a half-duplex mode may perform only one of transmission or reception during particular time resources, such as during particular slots, symbols, or other time periods. In various examples, some of the network nodes 110 and the UEs 120 of the wireless communication network 100 may be configured for full-duplex operation in addition to half-duplex operation. In full-duplex operation, a network node 110 or a UE 120 operating in a full-duplex (for example, SBFD) mode can transmit and receive communications concurrently (for example, in the same time resources). For example, as shown in FIG. 1, the network node 110b may operate in the full-duplex mode. The network node 110b may concurrently receive UL communications from the UE 120b and transmit DL communications to the UE 120c. By operating in a full-duplex mode, network nodes 110 or UEs 120 may generally increase the capacity of the network and the radio access link. In some examples, full-duplex operation may involve frequency division duplexing (FDD), in which DL transmissions of the network node 110b are performed in a first frequency band or on a first component carrier and transmissions of the UE 120b are performed in a second frequency band or on a second component carrier different than the first frequency band or the first component carrier, respectively. In some examples, full-duplex operation may be enabled for a UE 120 but not for a network node 110. For example, a UE 120 may simultaneously transmit a UL transmission to a first network node 110 and receive a DL transmission from a second network node 110 in the same time resources. In some other examples, full-duplex operation may be enabled for a network node 110 but not for a UE 120. For example, the network node 110b may simultaneously transmit a DL transmission to a first UE 120 (for example, the UE 120c) and receive a UL transmission from a second UE 120 (for example, the UE 120b) in the same time resources. In some other examples, full-duplex operation may be enabled for both a network node 110 and a UE 120.

As used herein, a DL signal may be or include a reference signal, control information, or data. For example, DL reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A DL signal carrying control information or data may be transmitted via a DL channel. DL channels may include one or more control channels for transmitting control information and one or more data channels for transmitting data. DL reference signals may be transmitted in addition to, or multiplexed with, DL control channel communications or DL data channel communications. A DL control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of DL or UL grants, slot format indicators (SFIs), preemption indicators (PIs), transmit power control (TPC) commands, hybrid automatic repeat request (HARQ) information, new data indicators (NDIs), among other examples. A DL data channel may be used to transmit DL data (for example, user data associated with a UE 120) from a network node 110 to a UE 120. DL control channels may include physical DL control channels (PDCCHs), and DL data channels may include physical DL shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, a UL signal may include a reference signal, control information, or data. For example, UL reference signals include a sounding reference signal (SRS), a PTRS, and a DMRS, among other examples. A UL signal carrying control information or data may be transmitted via a UL channel. A UL channel may include one or more control channels for transmitting control information and one or more data channels for transmitting data. UL reference signals may be transmitted in addition to, or multiplexed with, UL control channel communications or UL data channel communications. A UL control channel may be specifically used to transmit UL control information (UCI) from a UE 120 to a network node 110. A UL data channel may be used to transmit UL data (for example, user data associated with a UE 120) from a UE 120 to a network node 110. UL control channels may include physical UL control channels (PUCCHs), and UL data channels may include PUSCHs. Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), UL power control information (for example, a UL TPC parameter), or CSI, among other examples. CSI can include a channel quality indicator (CQI) (indicative of DL channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a DL signal or a UL signal. For example, the network node 110 may select an MCS for a DL signal in accordance with UCI received from the UE 120 or may transmit, to the UE 120, an indication of an MCS to be applied for a UL signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for DL or UL transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more DL or UL signal measurements. The network node 110a or the UE 120a may transmit the processed DL or UL signals, respectively, via one or more antennas.

The network node 110a or the UE 120a may receive UL signals or DL signals, respectively, via one or more antennas. The network node 110a or the UE 120a (for example, using the processing system 145 or the processing system 140, respectively, or one or more coupled modems) may perform signal processing (for example, in accordance with the MCS) on the received UL or DL signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the DL or UL signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the DL or UL signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples.

In some aspects, the UE 120 may include a communication manager 150. As described in more detail elsewhere herein, the communication manager 150 may obtain a UL resource muting configuration indication related to a plurality of symbols, the UL resource muting configuration indication indicating whether to apply UL resource muting to at least one non-SBFD symbol of a set of non-SBFD symbols among the plurality of symbols; and transmit, to a network node 110, a PUSCH message in one or more symbols, of the plurality of symbols, in accordance with the UL resource muting configuration indication. Additionally, or alternatively, the communication manager 150 may perform one or more other operations described herein.

In some aspects, the network node 110 may include a communication manager 155. As described in more detail elsewhere herein, the communication manager 155 may transmit, to a UE 120, a UL resource muting configuration indication related to a plurality of symbols, UL resource muting configuration indication indicating whether to apply UL resource muting to at least one non-SBFD symbol of a set of non-SBFD symbols among the plurality of symbols; and receive, from the UE 120, a PUSCH message in one or more symbols, of the plurality of symbols, in accordance with the UL resource muting configuration indication. Additionally, or alternatively, the communication manager 155 may perform one or more other operations described herein.

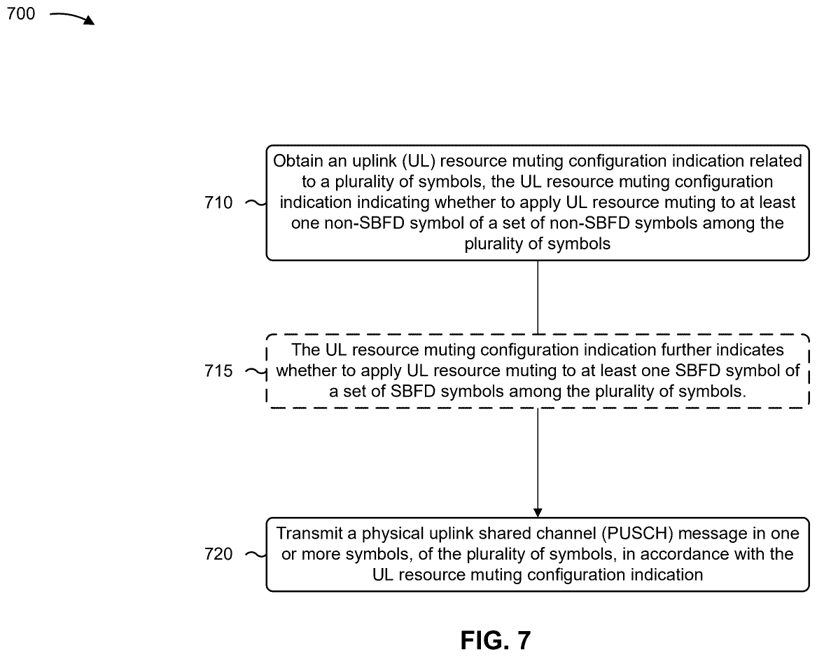

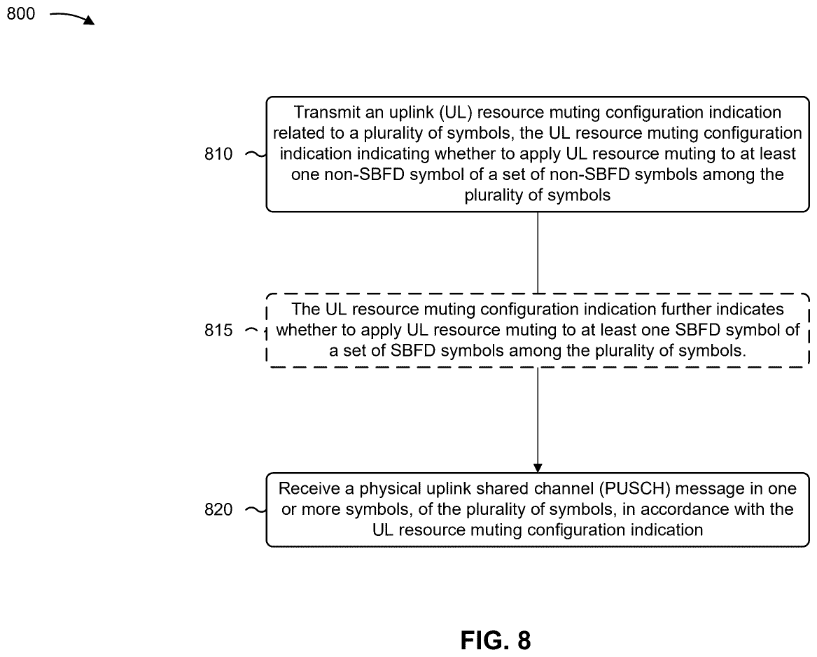

The network node 110, the processing system 145 of the network node 110, the UE 120, the processing system 140 of the UE 120, or any other component(s) of FIG. 1 may implement one or more techniques or perform one or more operations associated with UL resource muting configurations, as described in more detail elsewhere herein. For example, the processing system 145 of the network node 110, or the processing system 140 of the UE 120 may perform or direct operations of, for example, process 700 of FIG. 7, process 800 of FIG. 8, or other processes as described herein (alone or in conjunction with one or more other processors). Memory of the network node 110 may store data and program code (or instructions) for the network node 110. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, or the UE 120, may cause the one or more processors to perform process 700 of FIG. 7, process 800 of FIG. 8, or other processes as described herein. In some examples, executing instructions may include running the instructions, converting the instructions, compiling the instructions, or interpreting the instructions, among other examples.

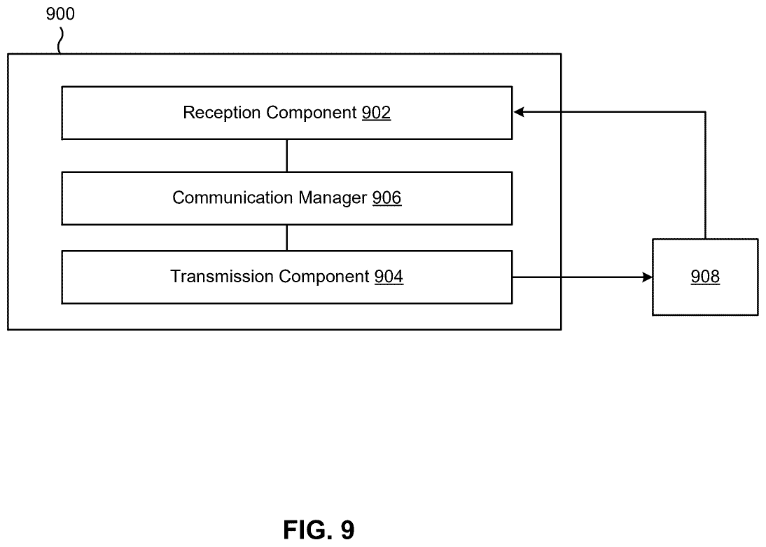

In some aspects, the UE 120 includes means for obtaining a UL resource muting configuration indication related to a plurality of symbols, the UL resource muting configuration indication indicating whether to apply UL resource muting to at least one non-SBFD symbol of a set of non-SBFD symbols among the plurality of symbols; or means for transmitting, to a network node 110, a PUSCH message in one or more symbols, of the plurality of symbols, in accordance with the UL resource muting configuration indication. The means for the UE 120 to perform operations described herein may include, for example, one or more of communication manager 150, processing system 140, a radio, one or more RF chains, one or more transceivers, one or more antennas, one or more modems, a reception component (for example, reception component 902 depicted and described in connection with FIG. 9), or a transmission component (for example, transmission component 904 depicted and described in connection with FIG. 9), among other examples.

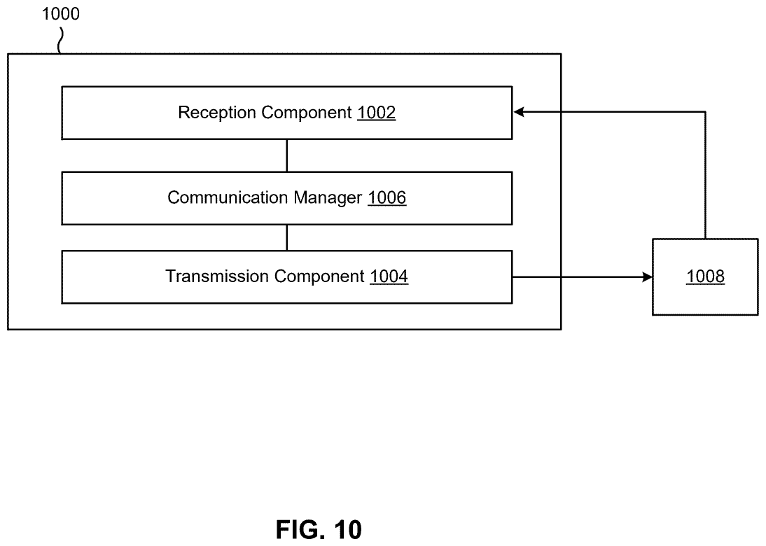

In some aspects, the network node 110 includes means for transmitting, to a UE 120, a UL resource muting configuration indication related to a plurality of symbols, the UL resource muting configuration indication indicating whether to apply UL resource muting to at least one non-SBFD symbol of a set of non-SBFD symbols among the plurality of symbols; or means for receiving, from the UE 120, a PUSCH message in one or more symbols, of the plurality of symbols, in accordance with the UL resource muting configuration indication. The means for the network node 110 to perform operations described herein may include, for example, one or more of communication manager 155, processing system 145, a radio, one or more RF chains, one or more transceivers, one or more antennas, one or more modems, a reception component (for example, reception component 1002 depicted and described in connection with FIG. 10), or a transmission component (for example, transmission component 1004 depicted and described in connection with FIG. 10), among other examples.

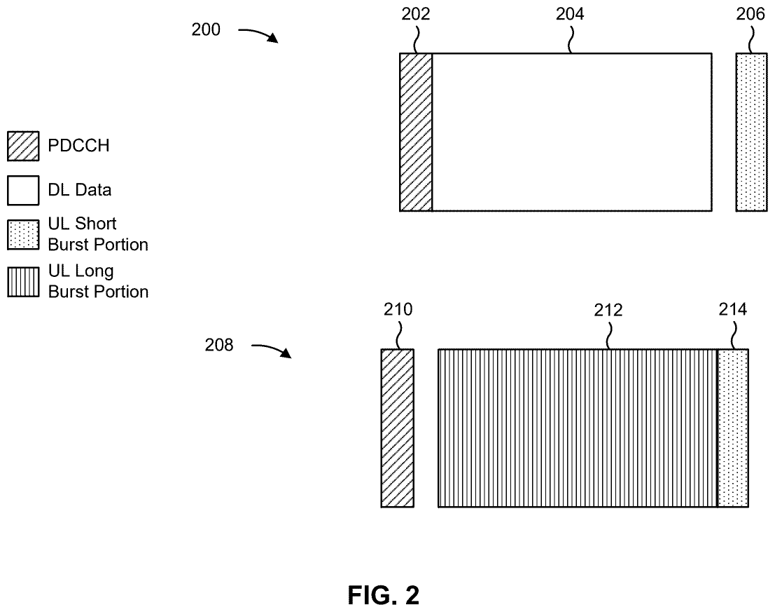

FIG. 2 is a diagram showing an example DL-centric slot or communication structure 200 and a UL-centric slot or communication structure 210. The DL-centric slot (or wireless communication structure) 200 may include a control portion 202 during which the scheduling entity (for example, UE or network node) transmits various scheduling information or control information corresponding to various portions of the DL-centric slot to the subordinate entity (for example, UE). The control portion 202 may exist in the initial or beginning portion of the DL-centric slot 200. In some configurations, the control portion 202 may be a physical DL control channel PDCCH, as indicated in FIG. 2. In some aspects, the control portion 202 may include legacy PDCCH information, shortened PDCCH (sPDCCH) information, a control format indicator (CFI) value (for example, carried on a physical control format indicator channel (PCFICH)), one or more grants (for example, DL grants, or UL grants), among other examples, or combinations thereof.

The DL-centric slot 200 may also include a DL data portion 204 during which the scheduling entity (for example, UE or network node) transmits DL data to the subordinate entity (for example, UE) using communication resources utilized to communicate DL data. The DL data portion 204 may sometimes be referred to as the payload of the DL-centric slot 200. In some configurations, the DL data portion 204 may be a PDSCH.

The DL-centric slot 200 may also include a UL short burst portion 206 during which the subordinate entity (for example, UE) transmits reference signals or feedback to the scheduling entity (for example, UE or network node) using communication resources utilized to communicate UL data. The UL short burst portion 206 may sometimes be referred to as a UL burst, a UL burst portion, a common UL burst, a short burst, a UL short burst, a common UL short burst, a common UL short burst portion, or various other suitable terms. In some aspects, the UL short burst portion 206 may include one or more reference signals. Additionally, or alternatively, the UL short burst portion 206 may include feedback information corresponding to various other portions of the DL-centric slot 200. For example, the UL short burst portion 206 may include feedback information corresponding to the control portion 202 or the data portion 204. Non-limiting examples of information that may be included in the UL short burst portion 206 include an ACK signal (for example, a PUCCH ACK, a PUSCH ACK, or an immediate ACK), a NACK signal (for example, a PUCCH NACK, a PUSCH NACK, or an immediate NACK), an SR, a buffer status report (BSR), a HARQ indicator, a CSI, a CQI, an SRS, a DMRS, PUSCH data, or various other suitable types of information. The UL short burst portion 206 may include additional or alternative information, such as information pertaining to random access channel (RACH) procedures, scheduling requests, and various other suitable types of information.

As illustrated in FIG. 2, the end of the DL data portion 204 may be separated in time from the beginning of the UL short burst portion 206. This time separation may sometimes be referred to as a gap, a guard period, a guard interval, or various other suitable terms. This separation provides time for the switch-over from DL communication (for example, reception operation by the subordinate entity (for example, network node or UE)) to UL communication (for example, transmission by the subordinate entity (for example, UE)). The foregoing provides some examples of a DL-centric wireless communication structure, but alternative structures having similar features may exist without deviating from the aspects described herein.

The UL-centric slot (or wireless communication structure) 208 may include a control portion 210. The control portion 210 may exist in the initial or beginning portion of the UL-centric slot 208. The control portion 210 in may be similar to the control portion 202 described above with reference to the DL-centric slot 200. The UL-centric slot 208 may also include a UL long burst portion 212. The UL long burst portion 212 may sometimes be referred to as the payload of the UL-centric slot 208. The UL portion may refer to the communication resources utilized to communicate UL data from the subordinate entity (for example, UE) to the scheduling entity (for example, UE or network node). In some configurations, the control portion 210 may be a physical DL control channel PDCCH.

As illustrated, the end of the control portion 210 may be separated in time from the beginning of the UL long burst portion 212. This time separation may sometimes be referred to as a gap, guard period, guard interval, or various other suitable terms. This separation provides time for the switch-over from DL communication (for example, reception operation by the scheduling entity) to UL communication (for example, transmission operation by the scheduling entity).

The UL-centric slot 208 may also include a UL short burst portion 214. The UL short burst portion 214 may be similar to the UL short burst portion 206 described above with reference to the DL-centric slot 200, and may include any of the information described above. The foregoing is merely one example of a UL-centric wireless communication structure, and alternative structures having similar features may exist without deviating from the aspects described herein.

In one example, a wireless communication structure, such as a frame, may include both UL-centric slots and DL-centric slots. In this example, the ratio of UL-centric slots to DL-centric slots in a frame may be dynamically adjusted based at least in part on the amount of UL data and the amount of DL data that are transmitted. For example, if there is more UL data, then the ratio of UL-centric slots to DL-centric slots may be increased. Conversely, if there is more DL data, then the ratio of UL-centric slots to DL-centric slots may be decreased.

Additionally, dynamic slot configuration may be utilized to enable adaptive management of uplink and downlink resources, catering to different applications and user scenarios. This flexibility may be utilized in environments with fluctuating data usage, where the ability to dynamically adjust the balance between UL-centric and DL-centric slots can enhance network throughput and reduce latency. Additionally, advanced scheduling algorithms can further optimize the use of available spectrum, ensuring that both control and data channels are utilized effectively to support seamless communication across diverse network conditions.

As indicated above, FIG. 2 is provided as an example. Other examples may differ from what is provided with regard to FIG. 2.

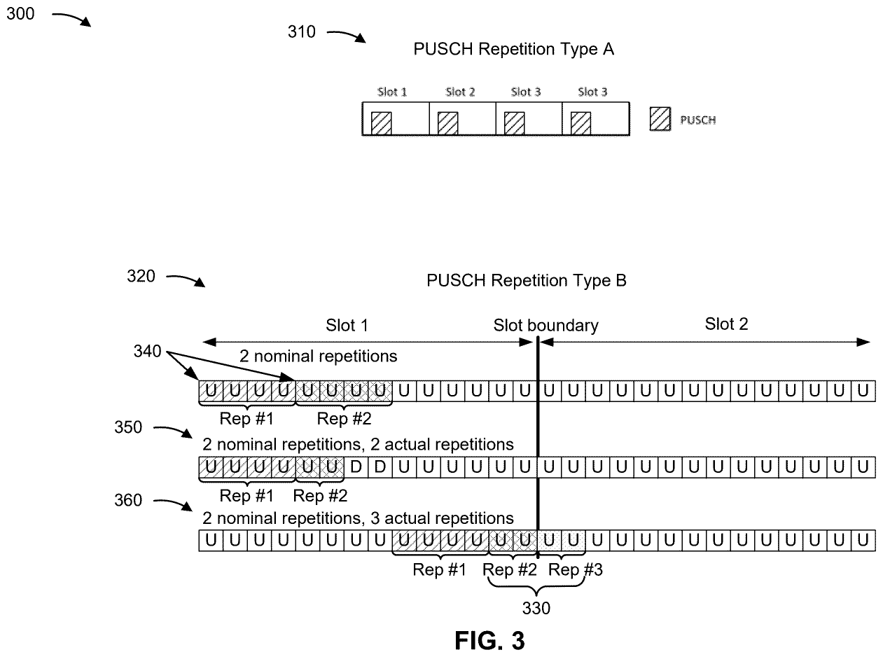

FIG. 3 is a diagram illustrating an example 300 of PUSCH Repetition Type A and PUSCH Repetition Type B. Although techniques are described herein in connection with PUSCH repetitions, these techniques can be applied to various types of uplink repetitions, such as an uplink data repetition, an uplink control repetition (e.g., a PUCCH repetition), or the like.

A repetition, such as an uplink repetition or a DL repetition, may be used to improve reliability, such as for URLLC or for UEs 120 located in a geographic area with poor channel conditions (e.g., a cell edge). When repetitions are used, a transmitter repeats transmission of a communication multiple times. For example, a UE 120 may transmit an initial uplink communication and may repeat transmission of (e.g., may retransmit) that uplink communication one or more times. When a UE 120 is configured with repetitions, the UE 120 may retransmit an initial transmission without first receiving feedback (e.g., an ACK or NACK) indicating whether the initial transmission was successfully received. In some aspects, ACK or NACK feedback may be disabled for repetitions, thereby reducing signaling overhead that would otherwise be used for ACK or NACK feedback.

In some aspects, a repeated transmission (sometimes referred to as a retransmission) may include the exact same encoded bits (e.g., information bits and parity bits) as the initial transmission or as another repeated transmission (e.g., where a same redundancy version is used across repetitions). Alternatively, a repeated transmission may include different encoded bits (e.g., a different combination of information bits or parity bits) than the initial transmission or another repeated transmission (e.g., where different redundancy versions are used across repetitions).

As used herein, the term “repetition” is used to refer to the initial communication and is also used to refer to a repeated transmission of the initial communication. For example, if the UE 120 is configured to transmit four repetitions, then the UE 120 may transmit an initial transmission and may transmit three repeated transmissions of that initial transmission. Thus, each transmission (regardless of whether the transmission is an initial transmission or a retransmission) is counted as a repetition. A repetition may be transmitted in a transmission occasion, which is sometimes referred to as a transmission instance.

As shown by reference number 310, for a first uplink repetition type referred to as PUSCH Repetition Type A, uplink transmission occasions are not permitted to cross a slot boundary, and only one uplink transmission occasion is permitted per slot. Thus, if a UE 120 is configured with PUSCH Repetition Type A, then the UE 120 cannot transmit a repetition in a set of symbols that occurs in more than one slot, and can only transmit the repetition if all symbols of the repetition occur in the same slot. Furthermore, if a UE 120 is configured with PUSCH Repetition Type A, then the UE 120 cannot transmit more than one repetition per slot. Thus, for PUSCH Repetition Type A, a transmission occasion corresponds to a slot. Furthermore, for PUSCH Repetition Type A, the time domain allocation for a repetition within a slot may be the same across all slots for which repetitions are scheduled. In other words, each repetition, associated with the same initial transmission, may start in the same starting symbol (e.g., having the same starting symbol index) in each slot in which a repetition is scheduled and may occupy the same number of symbols.

As shown by reference number 320, for a second uplink repetition type referred to as PUSCH Repetition Type B, uplink transmission occasions are permitted to cross a slot boundary (as shown by reference number 330, where a single nominal repetition crosses a slot boundary and is divided into two actual repetitions), and more than one uplink transmission occasion is permitted per slot (as shown by reference number 340). Thus, if a UE 120 is configured with PUSCH Repetition Type B, then the UE 120 can transmit a repetition (e.g., a nominal repetition) in a set of symbols that occurs in more than one slot, and the UE 120 can transmit the repetition even if all symbols of the repetition do not occur in the same slot. Furthermore, if a UE 120 is configured with PUSCH Repetition Type B, then the UE 120 can transmit more than one repetition per slot. Thus, for PUSCH Repetition Type B, a transmission occasion corresponds to a portion of a slot, such as a mini-slot. Furthermore, for PUSCH Repetition Type B, the time domain allocation for a repetition within a slot may be different for different repetitions. In other words, different repetitions, associated with the same initial transmission, may start in different starting symbols (e.g., having different starting symbol indexes).

In PUSCH Repetition Type B, the term “nominal repetition” refers to a potential PUSCH repetition as indicated by a network node 110. A nominal repetition signaled or scheduled by the network node 110 may be truncated or divided into one or two “actual repetitions.” A nominal repetition consists of a set of consecutive symbols over which the UE 120 is expected to transmit a PUSCH repetition. However, when this set of consecutive symbols crosses a slot boundary, contains semi-static DL symbols, or encounters (e.g., is scheduled to occur within) an invalid symbol pattern, among other examples, then the UE 120 is required to split the nominal repetition into one or two parts. Each of these parts is then referred to as an “actual repetition.”

For example, as shown by reference number 350, a PUSCH transmission may include four symbols, and a network node 110 may configure a UE 120 (e.g., in an RRC message) to transmit two nominal repetitions of the PUSCH transmission. The two nominal repetitions may span a total of eight symbols and may each include four symbols. The two nominal repetitions are scheduled in the first eight symbols of a slot (shown as Slot 1). For example, the first nominal repetition may be scheduled in the first four symbols of a slot (the first, second, third, and fourth symbols), and the second nominal repetition may be scheduled in the next four symbols of the slot (the fifth, sixth, seventh, and eighth symbols). The first nominal repetition is actually transmitted in the first four symbols and is thus treated as a single actual repetition (shown as “Rep #1”). For the second nominal repetition, the UE 120 actually transmits the first two symbols but cannot transmit the last two symbols because the last two symbols are DL symbols. Thus, the UE 120 drops the last two symbols, and the resulting actual repetition (shown as “Rep #2”) includes only the first two symbols.

As another example, as shown by reference number 360, a PUSCH transmission may include four symbols, and a network node 110 may configure a UE 120 to transmit two nominal repetitions of the PUSCH transmission. The two nominal repetitions may each include four symbols, shown as the ninth, tenth, eleventh, and twelfth symbols of a first slot (Slot 1) for a first nominal repetition, and shown as the thirteenth and fourteenth symbols of the first slot plus the first and second symbols of a second slot (Slot 2) for a second nominal repetition. The first nominal repetition is transmitted in four consecutive symbols and is thus treated as a single actual repetition (shown as “Rep #1”). The second nominal repetition is transmitted in consecutive symbols that cross a slot boundary (e.g., that occur in more than one slot) and is thus divided into two actual repetitions, with a first actual repetition (shown as “Rep #2”) being transmitted in a first set of consecutive symbols in the first slot (the thirteenth and fourteenth symbols of Slot 1) and a second actual repetition (shown as “Rep #3) being transmitted in a second set of consecutive symbols in the second slot (the first and second symbols of Slot 2).

Additionally, repetition techniques may enhance signal reliability and overcoming challenging channel conditions. For example, where multiple transmissions of the same data are utilized, delivery efficacy may be improved in environments with high interference or signal degradation. Furthermore, the ability to adapt repetition strategies based on network conditions allows for more efficient use of available resources, thereby contributing to improved overall network performance and user experience.

As indicated above, FIG. 3 is provided as an example. Other examples may differ from what is described with respect to FIG. 3.

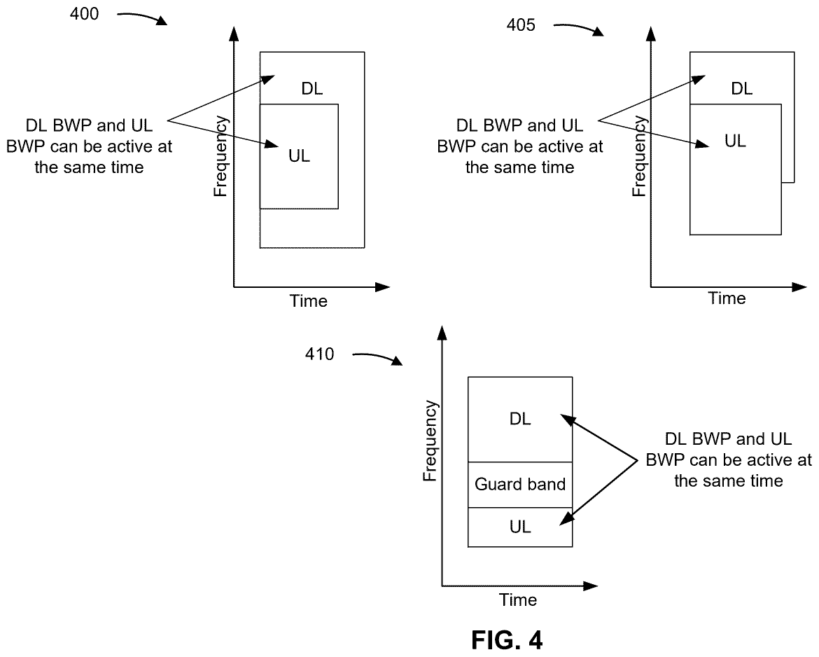

FIG. 4 is a diagram illustrating examples 400, 405, and 410 of full-duplex communication in a wireless network. “Full-duplex communication” in a wireless network refers to simultaneous bi-directional communication between devices in the wireless network. For example, a UE operating in a full-duplex mode may transmit an uplink communication and receive a DL communication at the same time (e.g., in the same slot or the same symbol). “Half-duplex communication” in a wireless network refers to unidirectional communications (e.g., only DL communication or only uplink communication) between devices at a given time (e.g., in a given slot or a given symbol).

As shown in FIG. 4, examples 400 and 405 show examples of in-band full-duplex (IBFD) communication. In IBFD, a UE may transmit an uplink communication to a network node and receive a DL communication from the network node on the same time and frequency resources. As shown in example 400, in a first example of IBFD, the time and frequency resources for uplink communication may fully overlap with the time and frequency resources for DL communication. As shown in example 405, in a second example of IBFD, the time and frequency resources for uplink communication may partially overlap with the time and frequency resources for DL communication.

As further shown in FIG. 4, example 410 shows an example of SBFD communication, which may also be referred to as “sub-band frequency division duplex (SBFDD)” or “flexible duplex.” In SBFD, a UE may transmit an uplink communication to a network node and receive a DL communication from the network node at the same time, but on different frequency resources. For example, the different frequency resources may be sub-bands of a frequency band, such as a time division duplexing band. In this case, the frequency resources used for DL communication may be separated from the frequency resources used for uplink communication, in the frequency domain, by a guard band.

As indicated above, FIG. 4 is provided as an example. Other examples may differ from what is described with respect to FIG. 4.

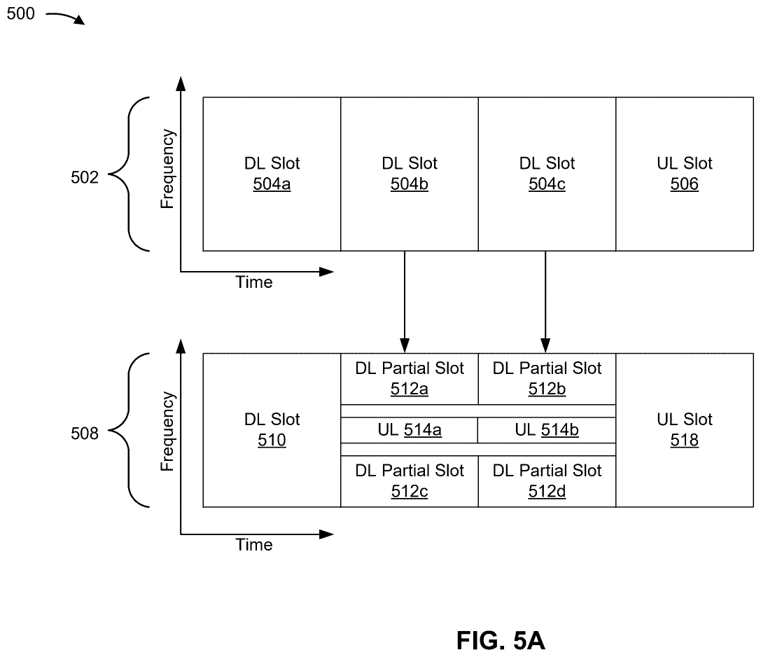

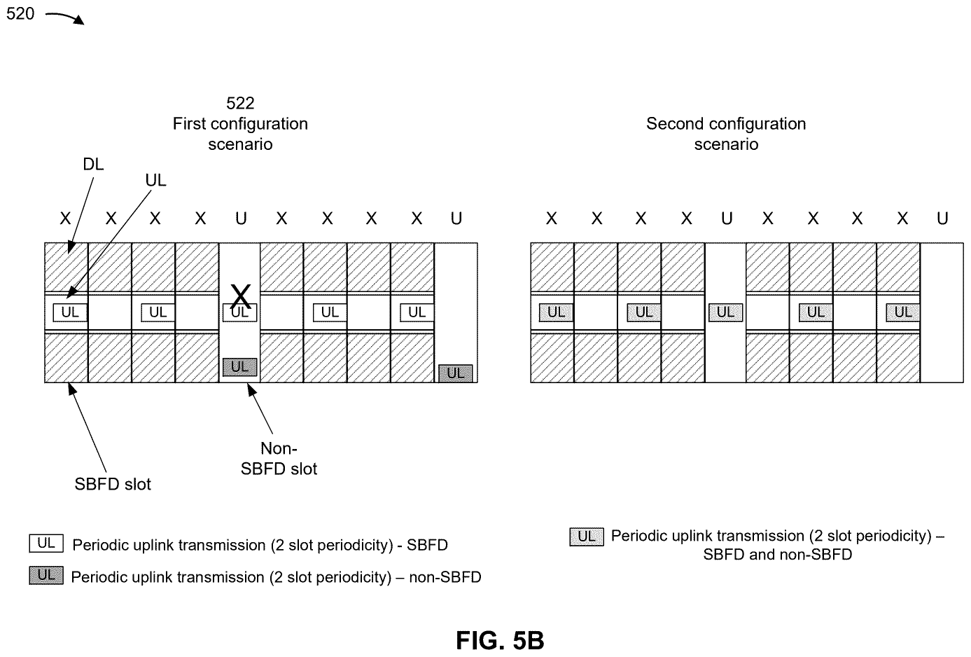

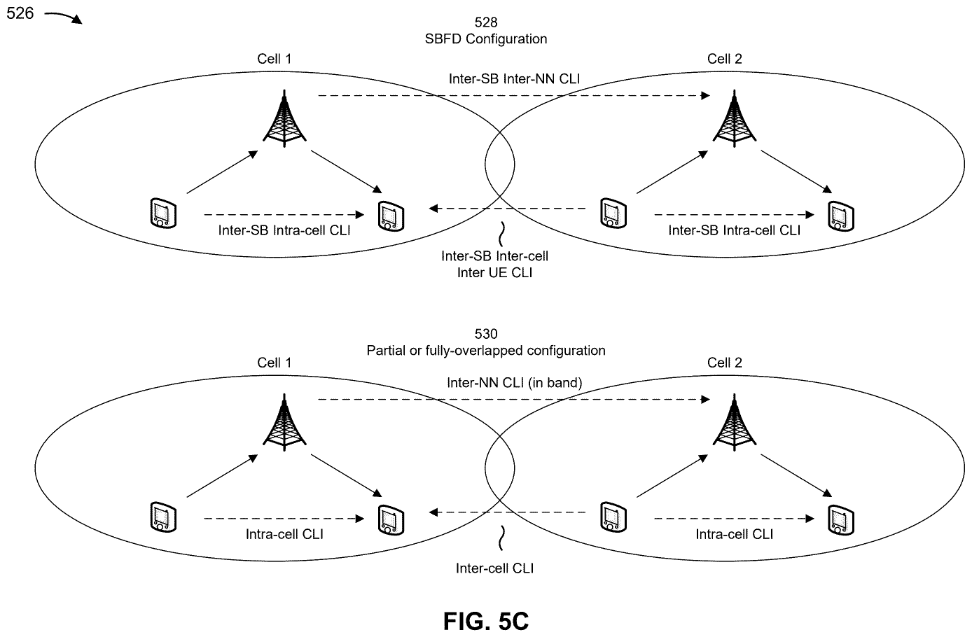

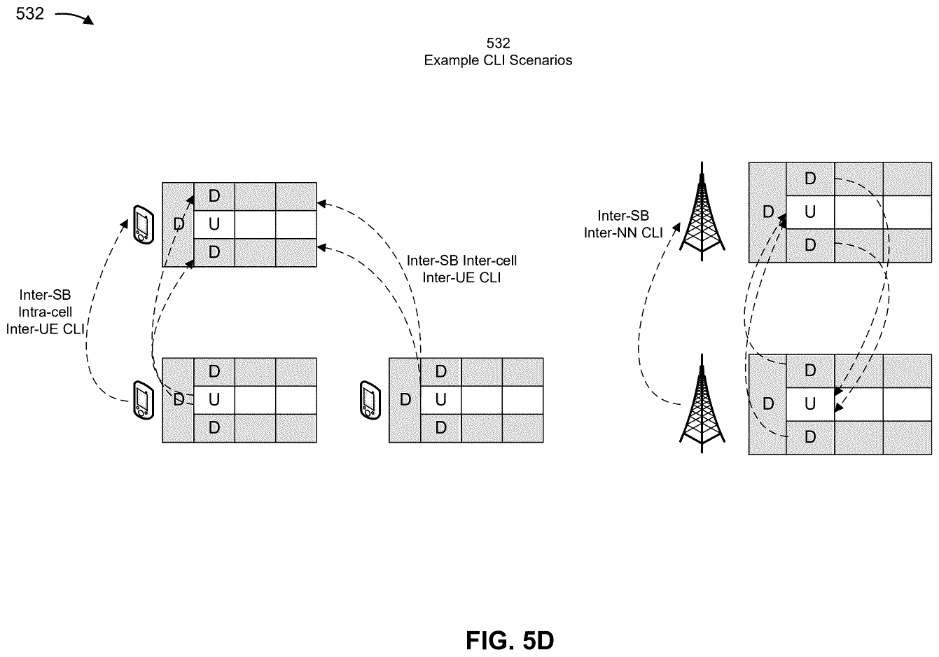

FIGS. 5A-5D are diagrams illustrating an example 500 of SBFD activation, an example 520 of configurations for SBFD transmissions and receptions across SBFD and non-SBFD symbols, and examples 526 and 532 of CLI scenarios. As shown in FIG. 5A, example 500 includes a first configuration 502. In some aspects, the first configuration 502 may indicate a first slot format pattern (sometimes called a TDD pattern) associated with a half-duplex mode or a full-duplex mode. The first slot format pattern may include a quantity of DL slots (e.g., three DL slots 504a, 504b, and 504c, as shown), a quantity of flexible slots (not shown), or a quantity of uplink slots (e.g., one UL slot 506, as shown). The first slot format pattern may repeat over time. In some aspects, a network node 110 may indicate the first slot format pattern to a UE 120 using one or more slot format indicators. A slot format indicator, for a slot, may indicate whether that slot is an uplink slot, a DL slot, or a flexible slot, among other examples.

A network node 110 may instruct (e.g., using an indication, such as an RRC message, a MAC-CE, or DCI) a UE 120 to switch from the first configuration 502 to a second configuration 508. As an alternative, the UE 120 may indicate to the network node 110 that the UE 120 is switching from the first configuration 502 to the second configuration 508. The second configuration 508 may indicate a second slot format pattern that repeats over time, similar to the first slot format pattern. In any of the aspects described above, the UE 120 may switch from the first configuration 502 to the second configuration 508 during a time period (e.g., a quantity of symbols or an amount of time (e.g., in milliseconds)) based at least in part on an indication received from the network node 110 (e.g., before switching back to the first configuration 502). During that time period, the UE 120 may communicate using the second slot format pattern, and then may revert to using the first slot format pattern after the end of the time period. The time period may be indicated by the network node 110 (e.g., in the instruction to switch from the first configuration 502 to the second configuration 508, as described above) or based at least in part on a programmed or otherwise preconfigured rule. For example, the rule may be based at least in part on a table (e.g., defined in 3GPP specifications or another wireless communication standard) that associates different SCSs or numerologies (e.g., represented by μ and associated with corresponding SCSs) with corresponding time periods for switching configurations.

In example 500, the second slot format pattern includes two SBFD slots in place of what were DL slots in the first slot format pattern. In example 500, each SBFD slot includes a partial slot (e.g., a portion or sub-band of a frequency allocated for use by the network node 110 and the UE 120) for DL (e.g., partial slots 512a, 512b, 512c, and 512d, as shown) and a partial slot for uplink (e.g., partial slots 514a and 514b, as shown). Accordingly, the UE 120 may operate using the second slot format pattern to transmit an uplink communication in an earlier slot (e.g., the second slot in sequence, shown as partial UL slot 514a) as compared to using the first slot format pattern (e.g., the fourth slot in sequence, shown as UL slot 506). Other examples may include additional or alternative changes. For example, the second configuration 508 may indicate an SBFD slot in place of what was an uplink slot in the first configuration 502 (e.g., UL slot 506). In another example, the second configuration 508 may indicate a DL slot 510 or an uplink slot 518 in place of what was an SBFD slot in the first configuration 502 (not shown in FIG. 5). In yet another example, the second configuration 508 may indicate a DL slot or an uplink slot in place of what was an uplink slot or a DL slot, respectively, in the first configuration 502. An “SBFD slot” may refer to a slot in which an SBFD format is used. An SBFD format may include a slot format in which full duplex communication is supported (e.g., for both uplink and DL communications), with one or more frequencies used for an uplink portion of the slot being separated from one or more frequencies used for a DL portion of the slot by a guard band. In some aspects, the SBFD format may include a single uplink portion and a single DL portion separated by a guard band. In some aspects, the SBFD format may include multiple DL portions and a single uplink portion that is separated from the multiple DL portions by respective guard bands (e.g., as shown in FIG. 5). In some aspects, an SBFD format may include multiple uplink portions and a single DL portion that is separated from the multiple uplink portions by respective guard bands. In some aspects, the SBFD format may include multiple uplink portions and multiple DL portions, where each uplink portion is separated from a DL portion by a guard band. In some aspects, operating using an SBFD mode may include activating or using a frequency duplexing (FD) mode in one or more slots based at least in part on the one or more slots having the SBFD format. A slot may support the SBFD mode if a UL BWP and a DL BWP are permitted to be or are simultaneously active in the slot in an SBFD fashion (e.g., with guard band separation).

By switching from the first configuration 502 to the second configuration 508, the network node 110 and the UE 120 may experience increased quality or reliability of communications. For example, the network node 110 and the UE 120 may experience increased throughput (e.g., using a full-duplex mode), reduced latency (e.g., the UE 120 may be able to transmit an uplink or a DL communication sooner using the second configuration 508 rather than the first configuration 502), and increased network resource utilization (e.g., by using both the DL BWP and the UL BWP simultaneously instead of only the DL BWP or the UL BWP).

Additionally, in the context of the first configuration 502, when employing PUSCH repetition Type A within SBFD symbols, the same time location of none, one, or two UL muting symbols may be consistently applied across all PUSCH repetitions. This may enable uniformity in the muting pattern, thereby facilitating predictable and efficient resource allocation. Alternatively, for PUSCH repetition Type B within SBFD symbols under the same configuration, the muting pattern may include none, one, or two UL muting symbols applied per slot for all actual PUSCH repetitions. This approach allows for flexibility in managing UL resources while maintaining the integrity of the communication process, thereby optimizing the performance of the network node 110 and the UE 120 during full-duplex operations.

For example, as shown in FIG. 5B, and by reference number 522, in the first configuration, transmissions and receptions are restricted to SBFD symbols only or non-SBFD symbols only. In some examples, a wireless network may differentiate the configuration for SBFD versus non-SBFD where frequency resources may not be the same between an SBFD slot and a non-SBFD slot, causing for example, an SBFD uplink transmission to potentially collide with a non-SBFD DL reception. In some examples, a UE may not expect an SBFD transmission in a non-SBFD slot or a non-SBFD transmission in an SBFD slot. For example, where a non-SBFD slot includes an SBFD transmission, the SBFD transmission may be dropped according to the first configuration. However, where the non-SBFD slot includes a non-SBFD transmission, the non-SBFD transmission may not be dropped according to first configuration.

As shown by reference number 524, in the second configuration, transmissions and receptions may be in SBFD symbols and in non-SBFD symbols. In some examples, a UE may expect an SBFD transmission in a non-SBFD slot and a non-SBFD transmission in an SBFD slot.

In some examples, the SBFD-aware UE may be provided with the first configuration or the second configuration via an RRC configuration. Additionally, the RRC configuration may provide the SBFD-aware UE with the first configuration or the second configuration according to one or more granularity options. For example, in a first option, the SBFD-aware UE may be configured with the first configuration or the second configuration on a per-UE and per-serving cell basis. In a second option, the SBFD-aware UE may be configured with the first configuration or the second configuration on a per-UE, per-BWP, per-channel, or per-signal basis, where separate configurations for configured and dynamic transmissions or receptions for a given channel or signal may not be precluded. Additionally, in a third option, the SBFD-aware UE is configured with the first configuration or the second configuration on a per cell basis, where there may be no separate UE capabilities for the first configuration and the second configuration. These different options enable the UE to choose from among these options to adapt to current network conditions. For example, the first option may provide the most flexibility in choosing a configuration depending on the serving cell, the third option provides the least flexibility where the configuration is chosen for a cell with no separate UE capabilities for the first configuration and the second configuration, and the second option provides a level of flexibility between that of the first option and the third option.

As shown in FIG. 5C, and by reference number 528, a wireless network may implement an SBFD configuration in which inter-sub-band (SB) CLI can occur between network nodes across cells and between UEs within a cell, leading to potential communication disruption. Similarly, as shown by reference number 530, a partial or fully-overlapped configuration may be deployed in a wireless network. In this scenario, there may be inter-network-node CLI, where overlapping frequency resources between neighboring cells can result in interference. Furthermore, UEs within a cell may experience intra-cell CLI, and UEs in different cells may experience inter-cell CLI.

In some examples, a network node may utilize resource muting to accurately measure CLI. By selectively muting specific uplink resources, the network node can isolate the time-frequency domain needed to assess interference levels without the disruption of ongoing communications. This muting allows the network node to dedicate certain resources to the reception of interference signals, thereby enabling precise measurement of CLI. Accurate CLI measurement may enable identifying the sources and severity of interference, which in turn may the development of effective interference mitigation strategies.

As shown in FIG. 5D, and by reference number 532, in an SBFD configuration, CLI may occur between UEs within a cell on an inter-SB, intra-cell, inter-UE basis. Similarly, for UEs located in different cells, CLI may occur between UEs on an inter-SB, inter-cell, inter-UE basis. Furthermore, for two or more network nodes located in different cells, CLI may occur on an inter-SB, inter-network-node basis.

As indicated above, FIGS. 5A-5D are provided as examples. Other examples may differ from what is described with respect to FIGS. 5A-5D.

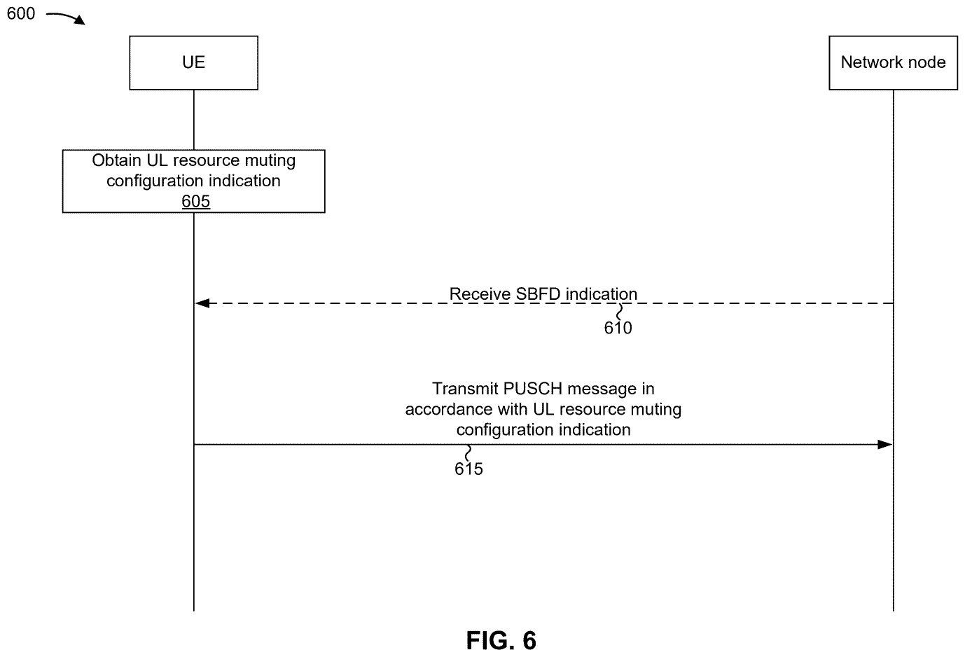

FIG. 6 is a diagram of an example implementation 600 associated with UL resource muting configurations. As shown in FIG. 6, example implementation 600 includes a UE (e.g., UE 120) and a network node (e.g., network node 110).

In some aspects, as shown by reference number 605, the UE may obtain a UL resource muting configuration indication related to a plurality of symbols, the UL resource muting configuration indication indicating whether to apply UL resource muting to at least one non-SBFD symbol of a set of non-SBFD symbols among the plurality of symbols. Additionally, in some aspects, the UL resource muting configuration indication may further indicate whether to apply UL resource muting to at least one SBFD symbol of a set of SBFD symbols among the plurality of symbols. For example, the UE may receive configuration information via RRC dedicated signaling that specifies UL resource muting on SBFD symbols in an SBFD scenario or in a dynamic TDD scenario. In this way, UL resource muting configuration may increase the efficacy of CLI measurement or mitigation by regulating the transmission power on specific symbols.

In some aspects, the UL resource muting configuration indication may be included in a UL resource muting configuration (e.g., where the UE may obtain the UL resource muting configuration from the network node, and the UE may obtain the UL resource muting configuration as part of obtaining the UL resource muting configuration indication or separately from obtaining the UL resource muting configuration indication), and the UL resource muting configuration may include a field that indicates a time and frequency location for each symbol, of the plurality of symbols, to which UL resource muting is applied. In some aspects, the UL resource muting configuration may incorporate an information element (IE) (e.g., PUSCH-MutingResources), which may include an indication (e.g., a one-bit indication) to indicate the time and frequency location of UL muting resources. In some aspects, the UL muting pattern can be configured to apply to no symbols, one symbol, or two symbols within a slot, with a configurable comb offset. For example, this approach enables targeted muting of symbols during periods of high potential interference, thereby optimizing uplink communication and minimizing the impact of interference on network performance. By utilizing the PUSCH-MutingResources IE, the network node can transmit detailed muting instructions to the UE, ensuring that muting is applied effectively across different deployment scenarios. For example, the UL resource muting configuration indication may specify that muting should occur during periods of high potential interference based on historical network performance data, thereby providing more precise control over symbol muting.

Furthermore, for example, the network node may RRC signaling to transmit the UL resource muting configuration indication to the UE. This signaling may include a dedicated PUSCH-MutingResources IE, which may specify the time and frequency locations for each symbol to which UL resource muting is applied. The IE may contain one or more fields that indicate the UL resource muting pattern, allowing for either single-bit or bitmap indications. For example, a bitmap may outline the specific slots or symbols subject to muting within a given timeframe. Additionally, the network node may be configured to dynamically update these muting configurations based on real-time interference measurements obtained during CLI reference signal assessments. This dynamic updating ensures that the muting process adapts to changing network conditions, thereby optimizing uplink communication efficiency.

In some aspects, differentiation of UL resource muting behavior may be utilized for different PUSCH repetition types, such as PUSCH repetition Type A versus PUSCH repetition Type B, with associated configuration details. For example, for PUSCH repetition Type A in SBFD symbols with the first configuration, the same time location of none, one, or two UL muting symbols is applied for all PUSCH repetitions. For PUSCH repetition Type B in SBFD symbols with the first configuration, the same time location of none, one, or two UL muting symbols per slot may be applied for all PUSCH repetitions. Differentiating muting behavior based on repetition types may enable more tailored interference management, thereby decreasing the effects of interference while maintaining communication efficiencies and throughput.

In some aspects, the UL resource muting configuration indication may be used to indicate whether UL resource muting should be applied to non-SBFD symbols. For example, the UL resource muting configuration indication may include a UL resource muting IE that provides a single bit indication or a bitmap indication. For example, the UE may receive an indication through a UL resource muting PUSCH-MutingResources IE with a single bit indication or via separate indication signaling through RRC. Implementing these signaling indications may enhance the flexibility and responsiveness of UL resource muting configurations.

In some aspects, the UL resource muting configuration indication may be obtained from the network node. Additionally, or alternatively, the UL resource muting configuration indication may be included in a new (e.g., an additional) RRC IE. For example, the network node may transmit UL resource muting configuration details via a dedicated control channel. Obtaining configuration indications from the network node may facilitate dynamic adaptation to network conditions.

In some aspects, the UL resource muting configuration indication may be obtained from a wireless communication standard. For example, a wireless communication standard may indicate UL resource muting configurations based on one or more interference scenarios. Additionally, for example, the UL resource muting configuration indication may include a specification configuration that enables UL resource muting to apply to non-SBFD symbols (e.g., in order to measure inter-network-node CLI). In some aspects, the specification configuration may be utilized to address interference challenges in various deployment scenarios, such as flexible or dynamic TDD environments. For example, in a flexible or dynamic TDD scenario in which all symbols are non-SBFD symbols, inter-network-node CLI may occur when a DL slot of one cell interferes with a UL slot of a different cell. Accordingly, UL resource muting may be applied to these misaligned non-SBFD symbols in order to mitigate such interference.

For example, in scenarios where one cell operates with a slot format of XXXXX (e.g., where X represents an SBFD) and a different cell operates with a XXXXU slot format (e.g., where U represents a UL), inter-network-node CLI may occur not only on SBFD symbols or slots but also on the last U (e.g., non-SBFD) symbols or slots. Accordingly, applying UL resource muting to both SBFD and non-SBFD symbols may reduce inter-network-node CLI.

In some aspects, as shown by reference number 610, the network node may transmit, and the UE may receive, an SBFD indication that the network node supports an SBFD mode. For example, a UE in communications with a network node having SBFD capabilities may receive an indication via SIB signaling or via RRC dedicated signaling, indicating that the network node can manage simultaneous transmission and reception on sub-band frequencies. In this way, receiving an SBFD indication may enable the UE to adapt its transmission strategy, enhancing system capacity and resource utilization.

In some aspects, receiving an SBFD indication may include receiving either RRC dedicated signaling or a SIB message. For example, an SBFD indication may be transmitted as part of a scheduled update on system configuration signaling. In some aspects, the SBFD indication may be an SBFD time and frequency configuration. For example, the network may transmit a detailed configuration message indicating parameters for SBFD operation. Additionally, time and frequency configurations may help the UE align its transmissions with network expectations.

In some aspects, for an SBFD-capable network node, the network node may provide a UL resource muting configuration indication to the UE indicating whether to apply UL resource muting on non-SBFD symbols. For example, this UL resource muting configuration indication may be based on the slot format of one or more neighboring cells, which can be determined through TDD slot format information exchange. By utilizing this information, the network node can instruct the UE to selectively apply UL resource muting, thereby optimizing interference management in complex network environments.

In some aspects, where the UE is aware that the UE is in communication with an SBFD network node (e.g., having received a SBFD time and frequency configuration through SIB or RRC dedicated signaling), the UE may be configured (e.g., via a default configuration) to apply UL resource muting to all SBFD symbols. This configuration may be indicated by the network node's configuration of the UL resource muting IE, PUSCH-MutingResources. This IE may provide parameters for the UE to perform UL resource muting, thereby increasing the probability that SBFD symbols are managed in a manner that reduces interference and enhances communication efficiency.

In some aspects, where the UE is aware that it is in communication with an SBFD network node (e.g., having received a SBFD time and frequency configuration through SIB or RRC dedicated signaling), the UL resource muting configuration indication may indicate that UL resource muting is applied to only SBFD symbols. For example, the UE may receive a command to focus UL resource muting on only SBFD symbols during peak interference times. Focusing on UL resource muting of SBFD symbols may reduce excessive muting, thereby conserving resources. Additionally, for such a UL resource muting scheme, the UL resource muting configuration indication may be obtained from a wireless communication standard.

In some aspects (e.g., including SBFD and dynamic TDD deployments that experience inter-network-node CLI), UL resource muting may not be applied to non-SBFD symbols. For example, in an SBFD scenario, inter-network-node CLI may occur on both SBFD and non-SBFD symbols, as described herein. However, in a scenario in which two cells each have a XXXXU slot format (e.g., where X represents SBFD and U represents a non-SBFD UL), inter-network-node CLI may only occur on SBFD symbols, and may not occur on non-SBFD (e.g., U) symbols. Accordingly, the UE may refrain from applying UL resource muting to non-SBFD symbols.

In some aspects, where the UE is aware that it is in communication with an SBFD network node (e.g., having received a SBFD time and frequency configuration through SIB or RRC dedicated signaling), the UL resource muting configuration indication may indicate that UL resource muting is applied to both SBFD symbols and non-SBFD symbols. For example, in high-interference environments, muting may be applied broadly.

In some aspects, the UL resource muting configuration indication may include a field indicating whether to apply UL resource muting to non-SBFD symbols, based on the receipt or non-receipt of the SBFD indication. For example, upon receiving the SBFD indication, the UE may reference this field to determine its muting actions for SBFD symbols. Including a dedicated field for SBFD-specific muting instructions may enable the UE to adjust its behavior to align with the network node's SBFD capabilities, ensuring efficient interference management during SBFD operations.

Alternatively, the UE may determine that the network node does not support SBFD modes, thereby identifying it as a non-SBFD network node. For example, the UE may determine that the network node does not support SBFD modes based on the UE not receiving the SBFD indication (e.g., based on the non-receipt of the SBFD indication, or the non-receipt of SBFD time and frequency configuration information through SIB (e.g., SIB1) or RRC dedicated signaling). In such a scenario, the absence of an SBFD configuration indicates to the UE that the network node is operating in a non-SBFD mode. Consequently, the UE may adjust its uplink resource muting strategy to accommodate the non-SBFD mode. This adaptive approach ensures that the UE can optimize its communication strategy based on the network node's capabilities, even in the absence of explicit SBFD support.

Additionally, where the UE does not receive an indication that the network node supports an SBFD mode, the UE may obtain the UL resource muting configuration indication from a wireless communication standard. In some aspects, the UL resource muting configuration indication may indicate that UL resource muting is applied to all non-SBFD symbols, based on an absence of receiving an indication that the network node supports an SBFD mode. For example, in networks without SBFD support, the UE may default to muting all non-SBFD symbols in order to prevent interference. Additionally, in some aspects, applying UL resource muting to all non-SBFD symbols may ensure consistent communication quality.

Furthermore, where the UE receives the UL resource muting PUSCH-MutingResources IE from the network node, the UE may be aware (e.g., implicitly aware) that the cell related to the network node is functioning as a dynamic or flexible TDD cell. As a result, the UE may apply UL muting to all non-SBFD symbols (e.g., UL or flexible (F) symbols), to manage interference and optimize communication within the dynamic TDD environment.

Alternatively, where the UE does not receive the PUSCH-MutingResources IE from the network node, the UE may be aware (e.g., implicitly aware) that the cell related to the network node is an aligned TDD cell. As a result, the UE may refrain from applying UL muting to any non-SBFD symbols (e.g., UL or F symbols), as aligned TDD configuration may not utilize muting for interference management. Such an adaptive approach enables the UE to tailor its muting strategy based on the network node's operational mode, ensuring efficient communication and interference mitigation in varying TDD scenarios.

In some aspects, where the UE does not receive an indication that the network node supports an SBFD mode, the UE may obtain the UL resource muting configuration indication from the network node. In some aspects, the UL resource muting configuration indication may indicate whether to apply UL resource muting to one or more slots of one or more non-SBFD symbols, of the set of non-SBFD symbols. For example, the configuration may contain a bitmap indicating whether specific slots should be muted based on historical interference patterns. Slot-specific muting may improve uplink performance and may enable measurement and mitigation of CLI.

For example, such a UL resource muting configuration indication may be utilized in circumstances involving inter-network-node CLI, such as where a first cell includes a DDDUU pattern and a second cell includes a DDUDU pattern. In such an example, inter-network-node CLI may occur only on misaligned U slots, but may not occur on the last aligned U slot. As a result, UL resource muting may be applied to only misaligned non-SBFD or U slots.

In some aspects, the network node may transmit such a UL resource muting configuration indication to the UE using a single bit format. Alternatively, the network node may transmit such a UL resource muting configuration indication in a bitmap format, where the UL resource muting configuration indication may indicate whether UL resource muting should be applied to non-SBFD symbols on a per symbol or per slot basis. For example, the bitmap may indicate the misaligned symbol or slot indices for UL resource muting. In some aspects, the UL resource muting configuration indication may be included in the PUSCH-MutingResources IE, which may include the single bit indication or the bitmap indication. Alternatively, the network node may utilize separate signaling via RRC to communicate the UL resource muting configuration indication that indicates the UL resource muting for non-SBFD symbols.

By providing indications on UL resource muting application, the network node may enable the UE to adapt its interference management strategy in order to enable improved communication or interference performance in non-SBFD environments. For example, the UE may dynamically adjust UL resource muting based on real-time network configurations and interference patterns, enhancing overall system efficiency.

Additionally, or alternatively, the PUSCH may be related to a timed domain resource allocation (TDRA) field that may be configured for on/off UL resource muting per PUSCH (e.g., the TDRA field may dynamically configure the “on” application or the “off” application of the UL resource muting). In some aspects, where the TDRA field for on/off UL resource muting is absent, the UE may apply UL resource muting to a PUSCH message. For example, where a [ul-MutingIndicator] is absent for a TDRA entry indicated for the PUSCH message, the UE may use UL resource muting for the PUSCH message. Such an approach may enable the UE to proactively manage potential interference by applying muting to the PUSCH transmission, thereby maintaining communication quality and reducing CLI.

Alternatively, where the TDRA field for on/off UL resource muting is absent, the UE may not apply UL resource muting to the PUSCH message. For example, where the [ul-MutingIndicator] is absent for a TDRA entry indicated for the PUSCH message, the UE may not use UL resource muting for the PUSCH message. For example, this approach may prioritize uninterrupted data throughput. These options provide flexibility in handling UL resource muting based on the dynamic configuration of the TDRA field, allowing for adaptive interference management tailored to network conditions or configurations.

In some aspects, as shown by reference number 615, the UE may transmit, and the network node may receive, a PUSCH message in one or more symbols, of the plurality of symbols, in accordance with the UL resource muting configuration indication. For example, the UE may adjust its PUSCH transmission to avoid certain SBFD or non-SBFD symbols that are subject to UL resource muting during periods of high interference. Additionally, the network node may utilize muted symbols to perform measurement of CLI during the respective time periods. In this way, adapting PUSCH transmissions according to muting configurations may improve the reliability and quality of uplink communications in dynamic network environments.

In some aspects, the UL resource muting configuration indication may provide instructions to the UE regarding the application of UL resource muting on non-SBFD symbols. This indication can be included in a PUSCH-MutingResources IE. In some aspects, the PUSCH-MutingResources IE may define a time and frequency location of UL muting resources and may configure muting patterns for up to two symbols within a slot, with a configurable comb offset.

Additionally, or alternatively, the UL resource muting configuration indication may be indicated by a single bit. Additionally, in some aspects, the PUSCH-MutingResources IE may contain a single bit indication that indicates to the UE whether to apply UL resource muting to non-SBFD symbols. For example, the single bit indication may be obtained from the network node.

Additionally, or alternatively, the UL resource muting configuration indication may be represented as a bitmap or the UL resource muting configuration indication may include a bitmap. For example, the bitmap may be obtained from the network node. This bitmap may provide an indication as to whether to apply UL resource muting to non-SBFD symbols on a per symbol or per slot basis, such as in misaligned symbol or slot indices. This granular approach may enable increased control over muting application across various symbols and slots. Furthermore, a separate indication signaling via RRC may be used to convey UL resource muting instructions. This signaling pathway may enable the UE to receive timely and accurate configuration details directly from the network node.

In some aspects, where the UL resource muting configuration indication field is absent, the UE may apply UL resource muting on only SBFD symbols, provided that SBFD symbols are configured (e.g., the network node is enabled for SBFD). This configuration may be received via SIB (e.g., SIB1) or RRC dedicated signaling. Alternatively, the application of UL resource muting may be determined based on a TDRA field's on/off status (e.g., in scenarios involving multiple PUSCH repetitions that span both SBFD and non-SBFD symbols). The indication (e.g., the TDRA field's on/off status) may assist in identifying non-SBFD repetition cases, ensuring that muting is applied appropriately across different transmission cycles.

In some aspects, UL resource muting may be applied to only SBFD symbols where the UE fails to obtain the UL resource muting configuration indication or if the UL resource muting configuration indication is not configured. For example, in scenarios where the UE does not receive the UL resource muting configuration indication regarding UL resource muting, the UE may apply muting on only SBFD symbols. This configuration may enable a configured level of interference management, focusing on SBFD symbols that are utilized for maintaining communication efficiency and reducing potential interference. By limiting UL resource muting to SBFD symbols in the absence of specific configuration indications, the UE can continue to manage interference effectively while awaiting further configuration details from the network node.

In some aspects, the PUSCH message may include zero, one, or two symbols to which UL resource muting is applied. For example, the UE may selectively mute symbols within its PUSCH message to reduce interference impact. In some aspects, when the PUSCH message includes one or two symbols to which UL resource muting is applied, the UL resource muting may be applied to alternating resource elements of entire allocations of the PUSCH message in each symbol to which UL resource muting is applied. For example, the UE may alternate muting across resource elements to balance power distribution. Alternating muting patterns may provide consistent interference control without disrupting communication.

As described herein, UL resource muting configurations may enable effective mitigation of CLI in TDD communication systems. In some aspects, a UE may obtain a UL resource muting configuration indication related to a plurality of symbols, including SBFD symbols and non-SBFD symbols, and the UE may transmit a PUSCH message in one or more symbols, in accordance with the UL resource muting configuration indication. For example, the UL resource muting configuration indication may indicate whether muting should be applied to SBFD symbols, non-SBFD symbols, or both.

In some aspects, the UL resource muting configuration indication may be provided via a network node using a signaling mechanism, such as RRC signaling or a SIB (e.g., SIB1) message. In some aspects, the UL resource muting configuration indication can include a single bit or a bitmap to specify muting configurations at symbol or slot levels. Additionally, the UL resource muting configuration indication may include configurations for muting behavior in cases where the indication is absent or not explicitly configured. For example, the UE may apply UL muting only to SBFD symbols if no explicit configuration is received, or the UE may apply UL muting to non-SBFD symbols if the network node does not support an SBFD mode.

As a result, by enabling precise UL resource muting configuration indications, the described techniques can enable measurement of CLI in SBFD, non-SBFD, or dynamic TDD scenarios, including in misaligned slot configurations across neighboring cells. This may result in a reduction in interference between UL and DL transmissions, thereby improving spectral efficiency and conserving network resources, such as transmission power and bandwidth. Additionally, UL resource muting may be applied in scenarios in which misaligned slots between cells result in cross-link interference. For example, where one cell operates in a dynamic TDD configuration and a different cell operates in a full duplex mode, applying UL resource muting to the misaligned uplink slots can significantly enhance interference mitigation.

Furthermore, by applying muting only to specific symbols or slots (e.g., misaligned non-SBFD symbols), the described techniques may reduce excessive resource utilization caused by over-muting. This selective muting may conserve processing resources and transmission resources while maintaining effective CLI mitigation tailored to deployment conditions, such as dynamic TDD and SBFD deployments. In further aspects, supporting consistent signaling mechanisms (e.g., RRC signaling and SIB messages) to convey muting configurations may improve coordination between UEs and network nodes, thereby reducing ambiguity in CLI mitigation strategies and conserving signaling bandwidth. In this way, the described techniques may conserve processing resources, network signaling resources, or transmission resources while maintaining effective CLI mitigation strategies.

FIG. 6 is provided as an example. Other examples may differ from what is described with regard to FIG. 6.

FIG. 7 is a diagram illustrating an example process 700 performed, for example, at a UE or an apparatus of a UE. Example process 700 is an example where the apparatus or the UE (e.g., UE 120) performs operations associated with UL resource muting configurations.

As shown in FIG. 7, in some aspects, process 700 may include obtaining a UL resource muting configuration indication related to a plurality of symbols, the UL resource muting configuration indication indicating whether to apply UL resource muting to at least one non-SBFD symbol of a set of non-SBFD symbols among the plurality of symbols (block 710). For example, the UE (e.g., using communication manager 906 or reception component, depicted in FIG. 9, or using processing system 140 of FIG. 1) may obtain a UL resource muting configuration indication related to a plurality of symbols, the UL resource muting configuration indication indicating whether to apply UL resource muting to at least one non-SBFD symbol of a set of non-SBFD symbols among the plurality of symbols, as described above, for example, with reference to FIG. 6.

As further shown in FIG. 7, in some aspects, process 700 may include the UL resource muting configuration indication further indicating whether to apply UL resource muting to at least one SBFD symbol of a set of SBFD symbols among the plurality of symbols (block 715).

As further shown in FIG. 7, in some aspects, process 700 may include transmitting, to a network node, a PUSCH message in one or more symbols, of the plurality of symbols, in accordance with the UL resource muting configuration indication (block 720). For example, the UE (e.g., using communication manager 150 or transmission component 904, depicted in FIG. 9) may transmit, to a network node, a

PUSCH message in one or more symbols, of the plurality of symbols, in accordance with the UL resource muting configuration indication, as described above, for example, with reference to FIG. 6.

Process 700 may include additional aspects, such as any single aspect or any combination of aspects described below or in connection with one or more other processes described elsewhere herein.

In a first aspect, the PUSCH message includes zero, one, or two symbols to which UL resource muting is applied.

The method of claim 2, where, when the PUSCH message includes one or two symbols to which UL resource muting is applied, the UL resource muting is applied to alternating resource elements of entire allocations of the PUSCH message in each symbol to which UL resource muting is applied.

In a second aspect, alone or in combination with the first aspect, the UL resource muting configuration indication is included in a UL resource muting configuration, and where the UL resource muting configuration includes a field that indicates a time and frequency location for each symbol, of the plurality of symbols, to which UL resource muting is applied.

In a third aspect, alone or in combination with one or more of the first and second aspects, process 700 includes receiving, from the network node prior to transmitting the PUSCH message, an SBFD indication that the network node supports an SBFD mode.

In a fourth aspect, alone or in combination with one or more of the first through third aspects, the SBFD indication is an SBFD time and frequency configuration.

In a fifth aspect, alone or in combination with one or more of the first through fourth aspects, the SBFD indication is received via either radio resource control dedicated signaling or a system information block message.

In a sixth aspect, alone or in combination with one or more of the first through fifth aspects, the UL resource muting configuration indication indicates that UL resource muting is applied to all SBFD symbols.

In a seventh aspect, alone or in combination with one or more of the first through sixth aspects, the UL resource muting configuration indication indicates that UL resource muting is applied to only SBFD symbols.

In an eighth aspect, alone or in combination with one or more of the first through seventh aspects, the UL resource muting configuration is obtained from a wireless communication standard.

In a ninth aspect, alone or in combination with one or more of the first through eighth aspects, the UL resource muting configuration indication indicates that UL resource muting is applied to both SBFD symbols and non-SBFD symbols.

In a tenth aspect, alone or in combination with one or more of the first through ninth aspects, the UL resource muting configuration indication indicates that UL resource muting is applied to non-SBFD symbols when the SBFD indication is received by the UE.

In an eleventh aspect, alone or in combination with one or more of the first through tenth aspects, the UL resource muting configuration indication is indicated by a single bit.

In a twelfth aspect, alone or in combination with one or more of the first through eleventh aspects, the UL resource muting configuration indication includes a bitmap indicating whether to apply UL resource muting to one or more non-SBFD symbols of the set of non-SBFD symbols.

In a thirteenth aspect, alone or in combination with one or more of the first through twelfth aspects, obtaining the UL resource muting configuration indication comprises receiving the UL resource muting configuration in a radio resource control message.

In a fourteenth aspect, alone or in combination with one or more of the first through thirteenth aspects, UL resource muting is applied to only SBFD symbols, in accordance with the UE failing to obtain the UL resource muting configuration indication or with the UL resource muting configuration indication not being configured.

In a fifteenth aspect, alone or in combination with one or more of the first through fourteenth aspects, the UL resource muting configuration indication indicates that UL resource muting is applied to all non-SBFD symbols when an indication that the network node supports an SBFD mode is not received by the UE.

In a sixteenth aspect, alone or in combination with one or more of the first through fifteenth aspects, the UL resource muting configuration indication is obtained from the network node.

In a seventeenth aspect, alone or in combination with one or more of the first through sixteenth aspects, the UL resource muting configuration indication is obtained from a wireless communication standard.

In an eighteenth aspect, alone or in combination with one or more of the first through seventeenth aspects, the UL resource muting configuration indication indicates whether to apply UL resource muting to one or more slots of one or more non-SBFD symbols, of the set of non-SBFD symbols.

In a nineteenth aspect, alone or in combination with one or more of the first through eighteenth aspects, the UL resource muting configuration indication is included in a [PUSCH-MutingResources] UL resource muting configuration radio resource control information element.

In a twentieth aspect, alone or in combination with one or more of the first through nineteenth aspects, the UL resource muting configuration indication is included in a new radio resource control information element.

In a twenty-first aspect, alone or in combination with one or more of the first through twentieth aspects, the UL resource muting configuration indication includes a single bit indicating whether to apply UL resource muting to the one or more slots of the one or more non-SBFD symbols.

In a twenty-second aspect, alone or in combination with one or more of the first through twenty-first aspects, the UL resource muting configuration indication includes a bitmap indicating whether to apply UL resource muting to the one or more slots of the one or more non-SBFD symbols.

In a twenty-third aspect, alone or in combination with one or more of the first through twenty-second aspects, the UE applies UL muting to only UL symbols or to only F symbols, or the UE applies UL muting to both UL symbols and F symbols, in accordance with the UE failing to receive the UL resource muting configuration indication and the UE failing to receive an indication that the network node supports an SBFD mode.

In a twenty-fourth aspect, alone or in combination with one or more of the first through twenty-third aspects, if a [ul-MutingIndicator] is absent for a TDRA entry indicated for the PUSCH message, UL muting is used for the PUSCH message.

In a twenty-fifth aspect, alone or in combination with one or more of the first through twenty-fourth aspects, if a [ul-MutingIndicator] is absent for a TDRA entry indicated for the PUSCH message, UL muting is not used for the PUSCH message.

In a twenty-sixth aspect, alone or in combination with one or more of the first through twenty-fifth aspects, process 700 includes receiving, from the network node, the UL resource muting configuration indication in a radio resource control message.

In a twenty-seventh aspect, along or in combination with one or more of the first through twenty-sixth aspects, the UL resource muting configuration indication further indicates whether to apply UL resource muting to at least one SBFD symbol of a set of SBFD symbols among the plurality of symbols.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, at a network node or an apparatus of a network node. Example process 800 is an example where the apparatus or the network node (e.g., network node 110) performs operations associated with UL resource muting configurations.

As shown in FIG. 8, in some aspects, process 800 may include transmitting, to a UE, a UL resource muting configuration indication related to a plurality of symbols, the UL resource muting configuration indication indicating whether to apply UL resource muting to at least one non-SBFD symbol of a set of non-SBFD symbols among the plurality of symbols (block 810). For example, the network node (e.g., using communication manager 150 or transmission component 1004, depicted in FIG. 10) may transmit, to a UE, a UL resource muting configuration indication related to a plurality of symbols, the UL resource muting configuration indication indicating whether to apply UL resource muting to at least one non-SBFD symbol of a set of non-SBFD symbols among the plurality of symbols, as described above, for example, with reference to FIG. 6.

As further shown in FIG. 8, in some aspects, process 800 may include the UL resource muting configuration indication further indicating whether to apply UL resource muting to at least one SBFD symbol of a set of SBFD symbols among the plurality of symbols (block 815).

As further shown in FIG. 8, in some aspects, process 800 may include receiving, from the UE, a PUSCH message in one or more symbols, of the plurality of symbols, in accordance with the UL resource muting configuration indication (block 820). For example, the network node (e.g., using communication manager 150 or reception component 1002, depicted in FIG. 10) may receive, from the UE, a PUSCH message in one or more symbols, of the plurality of symbols, in accordance with the UL resource muting configuration indication, as described above, for example, with reference to FIG. 6.

Process 800 may include additional aspects, such as any single aspect or any combination of aspects described below or in connection with one or more other processes described elsewhere herein.

In a first aspect, the PUSCH message includes zero, one, or two symbols to which UL resource muting is applied.

In a second aspect, alone or in combination with the first aspect, the UL resource muting configuration indication is included in a UL resource muting configuration, and where the UL resource muting configuration includes a field that indicates a time and frequency location for each symbol, of the plurality of symbols, to which UL resource muting is to be applied.

In a third aspect, alone or in combination with one or more of the first and second aspects, process 800 includes transmitting, to the UE prior to receiving the PUSCH message, an SBFD indication that the network node supports an SBFD mode.

In a fourth aspect, alone or in combination with one or more of the first through third aspects, the SBFD indication is an SBFD time and frequency configuration.

In a fifth aspect, alone or in combination with one or more of the first through fourth aspects, the SBFD indication is transmitted via either radio resource control dedicated signaling or a system information block message.

In a sixth aspect, alone or in combination with one or more of the first through fifth aspects, the UL resource muting configuration indication indicates that UL resource muting is applied to all SBFD symbols.

In a seventh aspect, alone or in combination with one or more of the first through sixth aspects, the UL resource muting configuration indication indicates that UL resource muting is applied to only SBFD symbols.

In an eighth aspect, alone or in combination with one or more of the first through seventh aspects, the UL resource muting configuration indication indicates that UL resource muting is applied to both SBFD symbols and non-SBFD symbols.

In a ninth aspect, alone or in combination with one or more of the first through eighth aspects, the resource muting configuration indication indicates that UL resource muting is applied to non-SBFD symbols when the SBFD indication is received by the UE.

In a tenth aspect, alone or in combination with one or more of the first through ninth aspects, the UL resource muting configuration indication is indicated by a single bit.

In an eleventh aspect, alone or in combination with one or more of the first through tenth aspects, the UL resource muting configuration indication includes a bitmap indicating whether to apply UL resource muting to one or more non-SBFD symbols of the set of non-SBFD symbols.

In a twelfth aspect, alone or in combination with one or more of the first through eleventh aspects, transmitting the UL resource muting configuration indication comprises transmitting, to the UE, the UL resource muting configuration indication in a radio resource control message.

In a thirteenth aspect, alone or in combination with one or more of the first through twelfth aspects, UL resource muting is applied to only SBFD symbols, in accordance with the UE failing to obtain the UL resource muting configuration indication or with the UL resource muting configuration indication not being configured.

In a fourteenth aspect, alone or in combination with one or more of the first through thirteenth aspects, the UL resource muting configuration indication indicates that UL resource muting is applied to all non-SBFD symbols when an indication that the network node supports an SBFD mode is not received by the UE.

In a fifteenth aspect, alone or in combination with one or more of the first through fourteenth aspects, the UL resource muting configuration indication indicates whether to apply UL resource muting to one or more slots of one or more non-SBFD symbols, of the set of non-SBFD symbols.

In a sixteenth aspect, alone or in combination with one or more of the first through fifteenth aspects, the UL resource muting configuration indication is included in a [PUSCH-MutingResources] UL resource muting configuration radio resource control information element.

In a seventeenth aspect, alone or in combination with one or more of the first through sixteenth aspects, the UL resource muting configuration indication is included in a new radio resource control information element.

In an eighteenth aspect, alone or in combination with one or more of the first through seventeenth aspects, the UL resource muting configuration indication indicates that, in accordance with an absence of receiving an indication that the network node supports an SBFD model, UL resource muting is applied to at least one slot, of the one or more slots, in accordance with the at least one slot being mis-aligned with at least one corresponding slot, and where the at least one slot is related to a first cell and the at least one corresponding slot is related to a second cell.

In a nineteenth aspect, alone or in combination with one or more of the first through eighteenth aspects, the UL resource muting configuration indication includes a single bit indicating whether to apply UL resource muting to the one or more slots of the one or more non-SBFD symbols.

In a twentieth aspect, alone or in combination with one or more of the first through nineteenth aspects, the UL resource muting configuration indication includes a bitmap indicating whether to apply UL resource muting to the one or more slots of the one or more non-SBFD symbols.

In a twenty-first aspect, alone or in combination with one or more of the first through twentieth aspects, process 800 includes transmitting, to the UE, the UL resource muting configuration in a radio resource control message.

In a twenty-second aspect, alone or in combination with one or more of the first through twenty-first aspects, the UL resource muting configuration indication further indicates whether to apply UL resource muting to at least one SBFD symbol of a set of SBFD symbols among the plurality of symbols.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication. The apparatus 900 may be a UE, or a UE may include the apparatus 900. In some aspects, the apparatus 900 includes a reception component 902, a transmission component 904, or a communication manager 906, which may be in communication with one another (for example, via one or more buses or one or more other components). In some aspects, the communication manager 906 is the communication manager 150 described in connection with FIG. 1. As shown, the apparatus 900 may communicate with another apparatus 908, such as a UE or a network node (such as a CU, a DU, an RU, or a base station), using the reception component 902 and the transmission component 904. The communication manager 906 may be included in, or implemented via, a processing system (for example, the processing system 140 described in connection with FIG. 1) of the UE.

In some aspects, the apparatus 900 may be configured to perform one or more operations described herein in connection with FIG. 6. Additionally, or alternatively, the apparatus 900 may be configured to perform one or more processes described herein, such as process 700 of FIG. 7. In some aspects, the apparatus 900 or one or more components shown in FIG. 9 may include one or more components of the UE described in connection with FIG. 1. Additionally, or alternatively, one or more components shown in FIG. 9 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications, and may provide the processed signals to the one or more other components of the apparatus 900. In some aspects, the reception component 902 may include one or more components of the UE described above in connection with FIG. 1, such as a radio, one or more RF chains, one or more transceivers, or one or more modems, each of which may in turn be coupled with one or more antennas of the UE.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications, and may transmit the processed signals to the apparatus 908. In some aspects, the transmission component 904 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 904 may be co-located with the reception component 902.

The communication manager 906 may support operations of the reception component 902 or the transmission component 904. For example, the communication manager 906 may receive information associated with configuring reception of communications by the reception component 902 or transmission of communications by the transmission component 904. Additionally, or alternatively, the communication manager 906 may generate or provide control information to the reception component 902 or the transmission component 904 to control reception or transmission of communications.

The reception component 902 may obtain a UL resource muting configuration indication related to a plurality of symbols, the UL resource muting configuration indication indicating whether to apply UL resource muting to at least one non-SBFD symbol of a set of non-SBFD symbols among the plurality of symbols. The transmission component 904 may transmit, to a network node, a PUSCH message in one or more symbols, of the plurality of symbols, in accordance with the UL resource muting configuration indication.

The reception component 902 may receive, from the network node prior to transmitting the PUSCH message, an SBFD indication that the network node supports an SBFD mode.

The reception component 902 may receive, from the network node, the UL resource muting configuration in a radio resource control message.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication. The apparatus 1000 may be a network node, or a network node may include the apparatus 1000. In some aspects, the apparatus 1000 includes a reception component 1002, a transmission component 1004, or a communication manager 1006, which may be in communication with one another (for example, via one or more buses or one or more other components). In some aspects, the communication manager 1006 is the communication manager 155 described in connection with FIG. 1. As shown, the apparatus 1000 may communicate with another apparatus 1008, such as a UE or a network node (such as a CU, a DU, an RU, or a base station), using the reception component 1002 and the transmission component 1004. The communication manager 1006 may be included in, or implemented via, a processing system (for example, the processing system 145 described in connection with FIG. 1) of the network node.

In some aspects, the apparatus 1000 may be configured to perform one or more operations described herein in connection with FIG. 6. Additionally, or alternatively, the apparatus 1000 may be configured to perform one or more processes described herein, such as process 800 of FIG. 8. In some aspects, the apparatus 1000 or one or more components shown in FIG. 10 may include one or more components of the network node described in connection with FIG. 1. Additionally, or alternatively, one or more components shown in FIG. 10 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications, and may provide the processed signals to the one or more other components of the apparatus 1000. In some aspects, the reception component 1002 may include one or more components of the network node described above in connection with FIG. 1, such as a radio, one or more RF chains, one or more transceivers, or one or more modems, each of which may in turn be coupled with one or more antennas of the network node. In some aspects, the reception component 1002 or the transmission component 1004 may include or may be included in a network interface. The network interface may be configured to obtain or output signals for the apparatus 1000 via one or more communications links, such as a backhaul link, a midhaul link, or a fronthaul link.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications, and may transmit the processed signals to the apparatus 1008. In some aspects, the transmission component 1004 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1004 may be co-located with the reception component 1002.

The communication manager 1006 may support operations of the reception component 1002 or the transmission component 1004. For example, the communication manager 1006 may receive information associated with configuring reception of communications by the reception component 1002 or transmission of communications by the transmission component 1004. Additionally, or alternatively, the communication manager 1006 may generate or provide control information to the reception component 1002 or the transmission component 1004 to control reception or transmission of communications.

The transmission component 1004 may transmit, to a UE, a UL resource muting configuration indication related to a plurality of symbols, the UL resource muting configuration indication indicating whether to apply UL resource muting to at least one non-SBFD symbol of a set of non-SBFD symbols among the plurality of symbols. The reception component 1002 may receive, from the UE, a PUSCH message in one or more symbols, of the plurality of symbols, in accordance with the UL resource muting configuration indication.

The transmission component 1004 may transmit, to the UE prior to receiving the PUSCH message, an SBFD indication that the network node supports an SBFD mode.

The transmission component 1004 may transmit, to the UE, the UL resource muting configuration in a radio resource control message.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a user equipment (UE), comprising: obtaining an uplink (UL) resource muting configuration indication related to a plurality of symbols, the UL resource muting configuration indication indicating whether to apply UL resource muting to at least one non-SBFD symbol of a set of non-SBFD symbols among the plurality of symbols; and transmitting, to a network node, a physical uplink shared channel (PUSCH) message in one or more symbols, of the plurality of symbols, in accordance with the UL resource muting configuration indication.

Aspect 2: The method of Aspect 1, wherein the UL resource muting configuration indication further indicates whether to apply UL resource muting to at least one SBFD symbol of a set of SBFD symbols among the plurality of symbols.

Aspect 3: The method of any of Aspects 1-2, wherein the PUSCH message includes zero, one, or two symbols to which UL resource muting is applied.

Aspect 4: The method of Aspect 3, wherein, when the PUSCH message includes one or two symbols to which UL resource muting is applied, the UL resource muting is applied to alternating resource elements of entire allocations of the PUSCH message in each symbol to which UL resource muting is applied.

Aspect 5: The method of any of Aspects 1-4, wherein the UL resource muting configuration indication is included in a UL resource muting configuration, and wherein the UL resource muting configuration includes a field that indicates a time and frequency location for each symbol, of the plurality of symbols, to which UL resource muting is applied.

Aspect 6: The method of any of Aspects 1-5, further comprising: receiving, from the network node prior to transmitting the PUSCH message, an SBFD indication that the network node supports an SBFD mode.

Aspect 7: The method of Aspect 6, wherein the SBFD indication is an SBFD time and frequency configuration.

Aspect 8: The method of Aspect 6, wherein the SBFD indication is received via either radio resource control dedicated signaling or a system information block message.

Aspect 9: The method of Aspect 6, wherein the UL resource muting configuration indication indicates that UL resource muting is applied to all SBFD symbols.

Aspect 10: The method of Aspect 6, wherein the UL resource muting configuration indication indicates that UL resource muting is applied to only SBFD symbols.

Aspect 11: The method of Aspect 10, wherein the UL resource muting configuration is obtained from a wireless communication standard.

Aspect 12: The method of Aspect 6, wherein the UL resource muting configuration indication indicates that UL resource muting is applied to both SBFD symbols and non-SBFD symbols.

Aspect 13: The method of Aspect 6, wherein the UL resource muting configuration indication indicates that UL resource muting is applied to non-SBFD symbols, when the SBFD indication is received by the UE.

Aspect 14: The method of Aspect 6, wherein the UL resource muting configuration indication is indicated by a single bit.

Aspect 15: The method of Aspect 6, wherein the UL resource muting configuration indication includes a bitmap indicating whether to apply UL resource muting to one or more non-SBFD symbols of the set of non-SBFD symbols.

Aspect 16: The method of Aspect 6, wherein obtaining the UL resource muting configuration indication comprises: receiving the UL resource muting configuration indication in a radio resource control message.

Aspect 17: The method of Aspect 6, wherein UL resource muting is applied to only SBFD symbols, in accordance with the UE failing to obtain the UL resource muting configuration indication or with the UL resource muting configuration indication not being configured.

Aspect 18: The method of any of Aspects 1-17, wherein the UL resource muting configuration indication indicates that UL resource muting is applied to all non-SBFD symbols when an indication that the network node supports an SBFD mode is not received by the UE.

Aspect 19: The method of any of Aspects 1-18, wherein the UL resource muting configuration indication is obtained from a wireless communication standard.

Aspect 20: The method of any of Aspects 1-19, wherein the UL resource muting configuration indication is obtained from the network node.

Aspect 21: The method of Aspect 20, wherein the UL resource muting configuration indication indicates whether to apply UL resource muting to one or more slots of one or more non-SBFD symbols, of the set of non-SBFD symbols.

Aspect 22: The method of Aspect 21, wherein the UL resource muting configuration indication is included in a [PUSCH-MutingResources] UL resource muting configuration radio resource control information element.

Aspect 23: The method of Aspect 21, wherein the UL resource muting configuration indication is included in a new radio resource control information element.

Aspect 24: The method of Aspect 21, wherein the UL resource muting configuration indication includes a single bit indicating whether to apply UL resource muting to the one or more slots of the one or more non-SBFD symbols.

Aspect 25: The method of Aspect 21, wherein the UL resource muting configuration indication includes a bitmap indicating whether to apply UL resource muting to the one or more slots of the one or more non-SBFD symbols.

Aspect 26: The method of Aspect 21, wherein the UE applies UL muting to only UL symbols or to only flexible (F) symbols, or the UE applies UL muting to both UL symbols and F symbols, in accordance with the UE failing to receive the UL resource muting configuration indication and the UE failing to receive an indication that the network node supports an SBFD mode.

Aspect 27: The method of Aspect 21, wherein if a [ul-MutingIndicator] is absent for a time domain resource allocation (TDRA) entry indicated for the PUSCH message, UL muting is used for the PUSCH message.

Aspect 28: The method of Aspect 21, wherein if a [ul-MutingIndicator] is absent for a time domain resource allocation (TDRA) entry indicated for the PUSCH message, UL muting is not used for the PUSCH message.

Aspect 29: The method of Aspect 20, further comprising: receiving, from the network node, a radio resource control signal that indicates whether to apply UL resource muting to one or more slots of one or more non-SBFD symbols, of the set of non-SBFD symbols.

Aspect 30: A method of wireless communication performed by a network node, comprising: transmitting, to a user equipment (UE), an uplink (UL) resource muting configuration indication related to a plurality of symbols, the UL resource muting configuration indication indicating whether to apply UL resource muting to at least one non-SBFD symbol of a set of non-SBFD symbols among the plurality of symbols; and receiving, from the UE, a physical uplink shared channel (PUSCH) message in one or more symbols, of the plurality of symbols, in accordance with the UL resource muting configuration indication.

Aspect 31: The method of Aspect 30, wherein the UL resource muting configuration indication further indicates whether to apply UL resource muting to at least one SBFD symbol of a set of SBFD symbols among the plurality of symbols.

Aspect 32: The method of any of Aspects 30-31, wherein the PUSCH message includes zero, one, or two symbols to which UL resource muting is applied.

Aspect 33: The method of any of Aspects 30-32, wherein the UL resource muting configuration indication is included in a UL resource muting configuration, and wherein the UL resource muting configuration includes a field that indicates a time and frequency location for each symbol, of the plurality of symbols, to which UL resource muting is to be applied.

Aspect 34: The method of any of Aspects 30-33, further comprising: transmitting, to the UE prior to receiving the PUSCH message, an SBFD indication that the network node supports an SBFD mode.

Aspect 35: The method of Aspect 34, wherein the SBFD indication is an SBFD time and frequency configuration.

Aspect 36: The method of Aspect 34, wherein the SBFD indication is transmitted via either radio resource control dedicated signaling or a system information block message.

Aspect 37: The method of Aspect 34, wherein the UL resource muting configuration indication indicates that UL resource muting is applied to all SBFD symbols.

Aspect 38: The method of Aspect 34, wherein the UL resource muting configuration indication indicates that UL resource muting is applied to only SBFD symbols.

Aspect 39: The method of Aspect 34, wherein the UL resource muting configuration indication indicates that UL resource muting is applied to both SBFD symbols and non-SBFD symbols.

Aspect 40: The method of Aspect 34, wherein the resource muting configuration indication indicates that UL resource muting is applied to non-SBFD symbols when the SBFD indication is received by the UE.

Aspect 41: The method of Aspect 34, wherein the UL resource muting configuration indication is indicated by a single bit.

Aspect 42: The method of Aspect 34, wherein the UL resource muting configuration indication includes a bitmap indicating whether to apply UL resource muting to one or more non-SBFD symbols of the set of non-SBFD symbols.

Aspect 43: The method of Aspect 34, wherein transmitting the UL resource muting configuration indication comprises: transmitting, to the UE, the UL resource muting configuration indication in a radio resource control message.

Aspect 44: The method of Aspect 34, wherein UL resource muting is applied to only SBFD symbols, in accordance with the UE failing to obtain the UL resource muting configuration indication or with the UL resource muting configuration indication not being configured.

Aspect 45: The method of any of Aspects 30-44, wherein the UL resource muting configuration indication indicates that UL resource muting is applied to all non-SBFD symbols when an indication that the network node supports an SBFD mode is not received by the UE.

Aspect 46: The method of any of Aspects 30-45, wherein the UL resource muting configuration indication indicates whether to apply UL resource muting to one or more slots of one or more non-SBFD symbols, of the set of non-SBFD symbols.

Aspect 47: The method of Aspect 46, wherein the UL resource muting configuration indication is included in a [PUSCH-MutingResources] UL resource muting configuration radio resource control information element.

Aspect 48: The method of Aspect 46, wherein the UL resource muting configuration indication is included in a new radio resource control information element.

Aspect 49: The method of Aspect 46, wherein the UL resource muting configuration indication indicates that, in accordance with an absence of receiving an indication that the network node supports an SBFD model, UL resource muting is applied to at least one slot, of the one or more slots, in accordance with the at least one slot being mis-aligned with at least one corresponding slot, and wherein the at least one slot is related to a first cell and the at least one corresponding slot is related to a second cell.

Aspect 50: The method of Aspect 46, wherein the UL resource muting configuration indication includes a single bit indicating whether to apply UL resource muting to the one or more slots of the one or more non-SBFD symbols.

Aspect 51: The method of Aspect 46, wherein the UL resource muting configuration indication includes a bitmap indicating whether to apply UL resource muting to the one or more slots of the one or more non-SBFD symbols.

Aspect 52: The method of any of Aspects 30-51, further comprising: transmitting, to the UE, a radio resource control signal that indicates whether to apply UL resource muting to one or more slots of one or more non-SBFD symbols, of the set of non-SBFD symbols.

Aspect 53: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-52.

Aspect 54: An apparatus for wireless communication at a device, the apparatus comprising one or more memories and one or more processors coupled to the one or more memories, the one or more processors configured to cause the device to perform the method of one or more of Aspects 1-52.

Aspect 55: An apparatus for wireless communication, the apparatus comprising at least one means for performing the method of one or more of Aspects 1-52.

Aspect 56: A non-transitory computer-readable medium storing code for wireless communication, the code comprising instructions executable by one or more processors to perform the method of one or more of Aspects 1-52.

Aspect 57: A non-transitory computer-readable medium storing a set of instructions for wireless communication, the set of instructions comprising one or more instructions that, when executed by one or more processors of a device, cause the device to perform the method of one or more of Aspects 1-52.

Aspect 58: A device for wireless communication, the device comprising a processing system that includes one or more processors and one or more memories coupled with the one or more processors, the processing system configured to cause the device to perform the method of one or more of Aspects 1-52.

Aspect 59: An apparatus for wireless communication at a device, the apparatus comprising one or more memories and one or more processors coupled to the one or more memories, the one or more processors individually or collectively configured to cause the device to perform the method of one or more of Aspects 1-52.

Aspect 60: A device comprising a processing system that includes one or more processors and one or more code-storing memories coupled with the one or more processors, the processing system configured to cause the device to perform the method of one or more of Aspects 1-52.

Aspect 61: A device comprising a processing system that includes processor circuitry and code-storing memory circuitry, the processing system configured to cause the device to perform the method of one or more of Aspects 1-52.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE), comprising:
a transceiver; and
a processing system that includes one or more processors and one or more code-storing memories coupled with the one or more processors, the processing system configured to:
obtain an uplink (UL) resource muting configuration indication related to a plurality of symbols, the UL resource muting configuration indication indicating whether to apply UL resource muting to at least one non-SBFD symbol of a set of non-SBFD symbols among the plurality of symbols; and
transmit, to a network node, a physical uplink shared channel (PUSCH) message in one or more symbols, of the plurality of symbols, in accordance with the UL resource muting configuration indication.

2. The UE of claim 1, wherein the UL resource muting configuration indication further indicates whether to apply UL resource muting to at least one SBFD symbol of a set of SBFD symbols among the plurality of symbols.

3. The UE of claim 1, wherein the PUSCH message includes zero, one, or two symbols to which UL resource muting is applied.

4. The UE of claim 1, wherein the processing system is configured to:
receive, from the network node prior to transmitting the PUSCH message, an SBFD indication that the network node supports an SBFD mode.

5. The UE of claim 4, wherein the SBFD indication is an SBFD time and frequency configuration.

6. The UE of claim 4, wherein the SBFD indication is received via either radio resource control dedicated signaling or a system information block message.

7. The UE of claim 4, wherein the UL resource muting configuration indication indicates that UL resource muting is applied to one of: all SBFD symbols, only SBFD symbols, or both SBFD symbols and non-SBFD symbols, based on the receipt or non-receipt of the SBFD indication.

8. The UE of claim 4, wherein the UL resource muting configuration indication is indicated by a single bit.

9. The UE of claim 4, wherein the UL resource muting configuration indication includes a bitmap indicating whether to apply UL resource muting to one or more non-SBFD symbols of the set of non-SBFD symbols.

10. The UE of claim 4, wherein the processing system, to obtain the UL resource muting configuration indication, is configured to:
receive the UL resource muting configuration in a radio resource control message.

11. The UE of claim 1, wherein the UL resource muting configuration indication is obtained from a wireless communication standard or from the network node.

12. A network node, comprising:
a processing system that includes one or more processors and one or more code-storing memories coupled with the one or more processors, the processing system configured to:
transmit, to a user equipment (UE), an uplink (UL) resource muting configuration indication related to a plurality of symbols, the UL resource muting configuration indication indicating whether to apply UL resource muting to at least one non-SBFD symbol of a set of non-SBFD symbols among the plurality of symbols; and
receive, from the UE, a physical uplink shared channel (PUSCH) message in one or more symbols, of the plurality of symbols, in accordance with the UL resource muting configuration indication.

13. The UE of claim 12, wherein the UL resource muting configuration indication further indicates whether to apply UL resource muting to at least one SBFD symbol of a set of SBFD symbols among the plurality of symbols.

14. The network node of claim 12, wherein the UL resource muting configuration indication indicates whether to apply UL resource muting to one or more slots of one or more non-SBFD symbols, of the set of non-SBFD symbols.

15. The network node of claim 14, wherein the UL resource muting configuration indication indicates that, in accordance with an absence of receiving an indication that the network node supports an SBFD model, UL resource muting is applied to at least one slot, of the one or more slots, in accordance with the at least one slot being mis-aligned with at least one corresponding slot, and
wherein the at least one slot is related to a first cell and the at least one corresponding slot is related to a second cell.

16. The network node of claim 12, wherein transmitting the UL resource muting configuration indication comprises:
transmitting, to the UE, the UL resource muting configuration indication in a radio resource control message.

17. The network node of claim 12, wherein the processing system is configured to:
transmit, to the UE prior to receiving the PUSCH message, an SBFD indication that the network node supports an SBFD mode.

18. The network node of claim 12, wherein the SBFD indication is an SBFD time and frequency configuration.

19. The network node of claim 12, wherein the UL resource muting configuration indication is indicated by a single bit.

20. A method of wireless communication performed by a user equipment (UE), comprising:
obtaining an uplink (UL) resource muting configuration indication related to a plurality of symbols, the UL resource muting configuration indication indicating whether to apply UL resource muting to at least one non-SBFD symbol of a set of non-SBFD symbols among the plurality of symbols; and
transmitting, to a network node, a physical uplink shared channel (PUSCH) message in one or more symbols, of the plurality of symbols, in accordance with the UL resource muting configuration indication.
